(19) United States
(12) Patent Application Publication
(10) Pub. No.: US 2022/0109219 A1
(43) Pub. Date: Apr. 7, 2022

(54) COAXIAL LOW-PASS FILTER

(71) Applicant: COM DEV Ltd., Mississauga (CA)

(72) Inventors: Rousslan Goulouev, Aylesbury (GB); Colin McLaren, Kings Langley (GB)

(21) Appl. No.: 17/062,171

(22) Filed: Oct. 2, 2020

(51) Int. Cl. H01P 1/205

(52) U.S. Cl. CPC H01P 1/205

(57) ABSTRACT

Various embodiments for a coaxial low-pass filter are described herein. Generally, the coaxial low-pass filter is operable to generate a stopband by a controlled generation of transmission zeroes within a stopband frequency range. The coaxial filter includes a plurality of cavity junctions, each of the plurality of cavity junctions operable to generate at least one corresponding cavity-specific transmission zero through a dual-mode coupling of a transverse electromagnetic and a transverse magnetic resonant mode, the at least one cavity-specific transmission zero being generated at at least one corresponding frequency located within the stopband frequency range, wherein for each cavity junction, the location of the cavity-specific frequency is adjusted by adjusting at least one property of the cavity junction, wherein a scattering of the locations of each of the cavity-specific transmission zeroes, generated by each of the plurality of cavity junctions, generates the stopband at the desired frequency range.

### FIELD

The described embodiments relate to low-pass filters, and in particular, to composite coaxial low-pass filters providing extended spurious-free stop bands.

### INTRODUCTION

The following is not an admission that anything discussed below is part of the prior art or part of the common general knowledge of a person skilled in the art.

Low-pass filters (LPFs) have found widespread application in many modern radio frequency (RF) and microwave communication instruments. LPFs operate to pass signals with low frequencies below a pre-determined cut-off frequency (e.g., the “pass band” of frequencies), while attenuating signals having frequencies above the frequency cut-off (e.g., the “stop band” of frequencies). In various cases, LPFs can be implemented using waveguide, coaxial, strip-line, micro-strip or lumped element structures.

In general, the ability of LPF structures to pass only select low frequency signals has made LPFs attractive for many low frequency applications, including various space and aerospace communication systems which predominantly rely on low frequency communication channels. The LPFs deployed in these communication instruments often rely on a coaxial line structure (e.g., composed of coaxial line sections), which interface with coaxial transmission lines carrying transmitted or received signals.

In recent years, technical and industry requirements has driven coaxial LPF design towards more selectivity to only pass signals in a highly narrowized low frequency range. In turn, these LPFs are expected to have an ultra-wide and continuous stopband bandwidth, which can include tens of harmonics (e.g., up to the 30^{th} harmonic, or 30 frequency multiples of the LPF cut-off frequency). These stringent design requirements are typically consequent of modern sensitive radio equipment—which are incorporated into various aerospace and satellite communication systems—which operate over selective channels, and are otherwise sensitive to unwanted or parasitic RF interference. In particular, many modern sensitive radio instruments require attenuation of unwanted harmonic frequencies in stopbands by up to 30 dB to 60 dB.

In view of the foregoing, significant challenges have emerged in designing coaxial LPF structures to demonstrate desired selective passband properties, while also providing high quality stopbands (e.g., stopbands demonstrating high attenuation of unwanted harmonic frequencies) which are both continuous and ultra-wide.

### SUMMARY OF VARIOUS EMBODIMENTS

In accordance with a broad aspect of the teachings herein, there is provided at least one embodiment of a coaxial low-pass filter operable to generate a stopband by a controlled generation of transmission zeroes within a stopband frequency range, the coaxial filter comprising: a plurality of cavity junctions arranged in cascaded sequence, each of the plurality of cavity junctions operable to generate at least one corresponding cavity-specific transmission zero through a dual-mode coupling of a transverse electromagnetic (TEM) resonant mode and a transverse magnetic (TM) resonant mode, the at least one cavity-specific transmission zero being generated at at least one corresponding cavity-specific frequency located within the stopband frequency range, wherein for each of the plurality of cavity junctions, the location of the at least one corresponding cavity-specific frequency is adjusted by adjusting at least one property of the corresponding cavity junction, wherein a scattering of the locations of each of the cavity-specific transmission zeroes, generated by each of the plurality of cavity junctions, generates the stopband at the desired frequency range.

In at least one of these embodiments, for at least a subset of the plurality of cavity junctions, the transverse electromagnetic (TEM) resonant mode is a TEM₁ resonant mode, and the transverse magnetic (TM) resonant mode is a TM₀₁₀ resonant mode.

In at least one of these embodiments, for at least a subset of the plurality of cavity junctions, the transverse electromagnetic (TEM) resonant mode is a TEM₁ resonant mode, and the transverse magnetic (TM) resonant mode is a TM₀₂₀ resonant mode.

In at least one of these embodiments, the plurality of cavity junctions comprise a first plurality of cavity junctions and a second plurality of cavity junctions, wherein for the first plurality cavity junctions the transverse electromagnetic (TEM) resonant mode is a TEM₁ resonant mode, and the transverse magnetic (TM) resonant mode is a TM₀₁₀ resonant mode, and for the second plurality cavity junctions the transverse electromagnetic (TEM) resonant mode is a TEM₁ resonant mode, and the transverse magnetic (TM) resonant mode is a TM₀₂₀ resonant mode.

In at least one of these embodiments, the at least subset of the plurality of cavity junctions generate transmission zeroes located at a near stopband region.

In at least one of these embodiments, the at least subset of the plurality of cavity junctions generate a low cut-off filter response.

In at least one of these embodiments, the at least subset of the plurality of cavity junctions generate transmission zeroes located at a far stopband region.

In at least one of these embodiments, the at least subset of the plurality of cavity junctions generate a high cut-off filter response for the coaxial filter.

In at least one of these embodiments, the at least one cavity-specific transmission zero comprises at least one of: two transmission zeroes generated at two corresponding cavity-specific frequencies, two transmission zeroes regenerated at a single cavity-specific frequency and a single transmission zero at a single cavity-specific frequency.

In at least one of these embodiments, the plurality of cavity junctions are cascaded in at least one of a periodic or quasi-periodic sequence.

In at least one of these embodiments, the at least one property comprises at least one of a length dimension of the cavity junction and a radius dimension of the cavity junction.

In at least one of these embodiments, the coaxial low-pass filter has a constant filter exterior resulting from the plurality of cavity junctions each having a constant cavity-specific radius.

In at least one of these embodiments, the coaxial low-pass filter has a tapered filter exterior resulting from the plurality of cavity junctions each having a variable cavity-specific radius.

In at least one of these embodiments, the coaxial low-pass filter has a stepped composite profile.

In at least one of these embodiments, the coaxial low-pass filter has a stepped and tampered composite profile.

In at least one of these embodiments, the coaxial filter is used in at least one of real frequency (RF) or microwave communication.

In at least one of these embodiments, the coaxial filter is used in satellite communication.

In at least one of these embodiments, the coaxial filter is used for low-frequency communication applications.

In at least one of these embodiments, the coaxial filter includes an input node and an output node, each of the input and output nodes are coupled to a coaxial transmission line carrying a transmission signal.

In at least one of these embodiments, the stopband is an extended spurious-free stopband range.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example communication system, according to some embodiments;

FIG. 2 is an example frequency response plot generated by an ideal low-pass filter;

FIG. 3A is a schematic illustration of the exterior of an example conventional low-pass filter (LPF) structure;

FIG. 3B is a cross-sectional view of the conventional LPF structure in FIG. 3A, along the section line 3B-3B′ of FIG. 3A;

FIG. 4A is an example simulated frequency response plot generated by the example conventional coaxial LPF structure of FIGS. 3A and 3B, and showing propagation of a dominant transverse electromagnetic mode (TEM);

FIG. 4B is an example frequency response plot for the example conventional coaxial LPF structure of FIGS. 3A and 3B, and showing propagation of spurious transverse electric (TE) modes;

FIG. 5A is a schematic illustration of an example cavity junction, in accordance with some embodiments;

FIG. 5B is a cross-sectional view of the example cavity junction of FIG. 5A, along the section line 5B-5B′ of FIG. 5A;

FIG. 5C is a schematic illustration of an example first type of cavity junction, in accordance with some embodiments;

FIG. 5D is a schematic illustration of an example second type of cavity junction, in accordance with some embodiments;

FIG. 6A an example frequency response plot generated by the example cavity junction of FIG. 5C, according to some embodiments;

FIG. 6B an example frequency response plot generated by the example cavity junction of FIG. 5C, according to some other embodiments;

FIG. 6C an example frequency response plot generated by the example cavity junction of FIG. 5C, according to still some other embodiments;

FIG. 6D an example frequency response plot generated by the example cavity junction of FIG. 5C, according to still yet some other embodiments;

FIG. 6E an example frequency response plot generated by the example cavity junction of FIG. 5C, according to some other embodiments;

FIG. 7A an example frequency response plot generated by the example cavity junction of FIG. 5D, according to some embodiments;

FIG. 7B an example frequency response plot generated by the example cavity junction of FIG. 5D, according to some other embodiments;

FIG. 7C an example frequency response plot generated by the example cavity junction of FIG. 5D, according to still some other embodiments;

FIG. 7D an example frequency response plot generated by the example cavity junction of FIG. 5D, according to still yet some other embodiments;

FIG. 8A is an example periodic structure formed from a second type of cavity junction;

FIG. 8B is a cross-sectional view of the example periodic structure of FIG. 8A, along the section line 8B-8B′ of FIG. 8A;

FIG. 9A is a schematic illustration of a cross-sectional view of an example LPF structure having a constant exterior, and configured to achieves a low cut-off response;

FIG. 9B is a simulated frequency response plot generated by the LPF structure of FIG. 9A, and showing the dominant TEM response;

FIG. 9C is a simulated frequency response plot generated by the LPF structure of FIG. 9A, and showing low-order TE spurious mode responses;

FIG. 9D is a simulated frequency plot generated by the LPF structure of FIG. 9A, and showing the insertion loss over a targeted passband;

FIG. 9E is another example embodiment of the coaxial LPF structure of FIG. 9A;

FIG. 10A is a schematic illustration of a cross-sectional view of an example LPF structure having a constant exterior, and configured to achieve a high cut-off response;

FIG. 10B is a simulated frequency response plot generated by the LPF structure of FIG. 10A, and showing the dominant TEM response;

FIG. 10C is a simulated frequency response plot generated by the LPF structure of FIG. 10A, and showing low-order TE spurious mode responses;

FIG. 11A is a schematic illustration of a cross-sectional view of an example LPF structure having a tapered exterior structure, and configured to achieves a low cut-off response;

FIG. 11B is a simulated frequency response plot generated by the LPF structure of FIG. 11A, and showing the dominant TEM response;

FIG. 11C is a simulated frequency response plot generated by the LPF structure of FIG. 11A, and showing low-order TE spurious mode responses;

FIG. 12A is a schematic illustration of a cross-sectional view of an example LPF structure having a tapered exterior structure, and configured to achieve a high cut-off response;

FIG. 12B is a simulated frequency plot generated by the LPF structure of FIG. 12A, and showing the dominant TEM response;

FIG. 12C is a simulated frequency plot generated by the LPF structure of FIG. 12A, and showing low-order TE spurious mode responses;

FIG. 13A is a schematic illustration of an example cross-sectional view of an example LPF structure having a stepped-profile exterior structure;

FIG. 13B is a simulated frequency plot generated by the LPF structure of FIG. 13A, and showing the dominant TEM response;

FIG. 13C is a simulated frequency plot generated by the LPF structure of FIG. 13A, and showing low-order TE spurious mode responses;

FIG. 13D is a simulated frequency plot generated by the LPF structure of FIG. 13A, and showing the insertion loss over the targeted passband;

FIG. 14A is a schematic illustration of a cross-sectional view of an example LPF structure having stepped and tapered profile exterior structure;

FIG. 14B is a simulated frequency plot generated by the LPF structure of FIG. 14A, and showing the dominant TEM mode response;

FIG. 14C is a simulated frequency plot generated by the LPF structure of FIG. 14A, and showing low-order TE spurious mode responses;

FIG. 15A is a schematic illustration of a cross-sectional view of an example LPF structure configured for a high cut-off response;

FIG. 15B is a simulated frequency plot generated by the LPF structure of FIG. 15A, and showing the dominant TEM response;

FIG. 15C is a simulated frequency plot generated by the LPF structure of FIG. 15A, and showing low-order TE spurious mode responses;

FIG. 16 is an equivalent π-network for modelling a cavity junction;

FIG. 17A is a characteristic impedance representation of an example cavity junction;

FIG. 17B is a characteristic impedance representation of an example periodic chain of cavity junctions;

FIG. 18 is a schematic representation of an example periodic LPF structure;

FIG. 19A is a schematic representation of a portion of a quasi-periodic LPF structure, showing the characteristic impedance and propagational wave number varying over longitudinal distance;

FIG. 19B is a schematic representation illustrating multiple connections of quasi-periodic portions, each having corresponding impedance and propagational wave numbers;

FIG. 20A is a schematic illustration of an example symmetric cavity junction;

FIG. 20B is a cross-sectional view of the symmetric cavity junction of FIG. 20A, along section line 20B-20B′ of FIG. 20A; and

FIG. 21 is an example frequency response plot, according to still some other embodiments.

Further aspects and features of the example embodiments described herein will appear from the following description taken together with the accompanying drawings.

### DETAILED DESCRIPTION OF THE EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

In the description and drawings herein, reference may be made to a Cartesian co-ordinate system in which the vertical direction, or z-axis, extends in an up and down orientation from bottom to top. The x-axis extends in a first horizontal or width dimension perpendicular to the z-axis, and the y-axis extends cross-wise horizontally relative to the x-axis in a second horizontal or length dimension.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant orientation relative to each other. None of the terms “coupled”, “connected”, “attached”, and “fastened” distinguish the manner in which two or more parts are joined together.

Low-pass filters (LPFs)—including coaxial LPFs—have found widespread application in many modern radio frequency (RF) and microwave communication instruments.

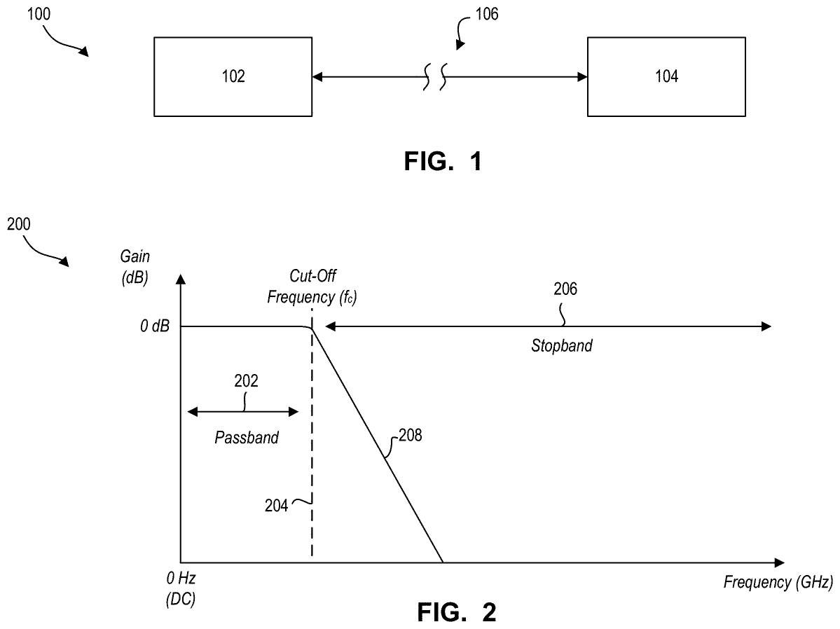

Referring briefly to FIG. 1, there is shown an example communication system 100. The system 100 may include a first transceiver 102 and a second transceiver 104 that communicate over a communication channel 106 (e.g., an RF or microwave communication channel). The transceivers 102, 104 may include RF or microwave communication instruments deployed, for example, on satellites or aircrafts. To enable transceivers 102, 104 to communicate over low frequency channels, coaxial LPF structures may be incorporated into the transceivers' communication systems so as to limit transmitted or received signals to the desired low frequency band corresponding to the communication channel. While both elements 102, 104 are illustrated as transceivers, in other cases, one or more of the transceivers 102, 104 may be simply configured as only transmitters and/or receivers.

As stated in the background, in recent years, requirements for coaxial LPF structures has emphasized more selective designs which pass only select and narrow frequency ranges, and demonstrate ultra-wide and continuous stopband bandwidths spanning tens of harmonics. As used herein, a harmonic is a relative frequency measure relative to the LPF cut-off frequency (e.g., a stop band stopping 7.5 harmonics stops 7.5 frequency multiples of the LPF cut-off frequency). A significant challenge, however, to designing coaxial LPFs with an ultra-wide and continuous stopband bandwidth is ensuring that the stopband is characterized by high quality.

Referring now to FIG. 2, which shows an example frequency response plot 200 for an example ideal low-pass filter (LPF).

As shown in the plot 200, the ideal behavior of an LPF is to generate a passband 202 of frequencies extending between zero hertz (e.g., direct current (DC)) to a pre-determined cut-off frequency (f_{c}) 204. The passband 202 represents a bandwidth of frequency signals passed by the LPF with no attenuation (e.g., a gain of 0 dB). In contrast, the LPF attenuates non-desirable frequency harmonics located above the cut-off frequency (f_{c}) 204, and within a stopband range 206. The transition between the passband 202 and the stopband 206 is often referred as the “roll-off” 208. In some cases, the LPF can be a low cut-off LPF wherein the cut-off frequency (f_{c}) 204 is in a low frequency range. In other cases, the LPF can be a high cut-off LPF, wherein the cut-off frequency (f_{c}) 204 is in a high frequency range.

Despite the ideal LPF behavior shown in FIG. 2, practical and real-implementations of LPF structures do not demonstrate similar idealistic behavior. In other words, practical and real-implementations of LPFs do not demonstrate—over a range of environmental conditions—complete out-of-band rejection (i.e., maximum attenuation of frequencies in the desired stopband), minimal in-band insertion loss (i.e., minimal attenuation in the desired passband owing to insertion loss of inserting the filter structure along the signal transmission path) as well as minimal in-band return loss (i.e., minimal attenuation in the passband owing to reflected signals inside discontinuities of the filter and/or transmission line).

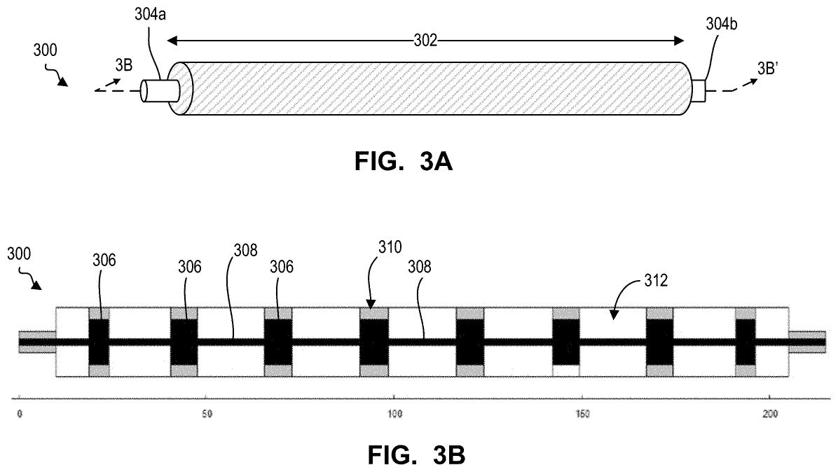

Referring now to FIGS. 3A and 3B concurrently, which schematically illustrate an example conventional coaxial low-pass filter (LPF) structure 300.

Although LPFs are practically realized using various structures (e.g., strip-lines, microstrips or lumped element structures), applications involving space or aerospace communication often deploy coaxial line based LPFs. More particularly, coaxial structures are characterized by a coaxial shape, or otherwise, a region of geometrical subtraction of an internal conductor area from an external conductor area. The internal conductor generally does not include breaks so as to allow the LPF to carry DC signals. In many cases, the coaxial cross-section has a concentric and rotationally symmetric structure, but can also include non-concentric cross-sectional shapes (e.g., rectangular, hexagonal, triangular, elliptical, etc.) The coaxial LPF structures are interfaced, at input and output nodes, with various signal carrying transmission lines (e.g., coaxial cables). In this manner, the LPF structure can receive, through the transmission line, input frequency signals and pass an output filtered low frequency signal.

As shown in FIGS. 3A and 3B, conventional coaxial LPF structures generally include a constant exterior (e.g., a constant radius, or diameter along the structure length 302), and include input/output interfaces 304a, 304b, to interface with transmission lines (e.g., a coaxial transmission line). In other cases, the LPF structure can also have other types of exterior designs, including a tapered exterior. In some cases, a connector transition interface is located at the interfaces 304a, 304b to allow the coaxial LPF to interface with other types of transmission lines (e.g., waveguides).

As shown in FIG. 3B, the conventional coaxial LPF 300 is composed from sequentially connected discontinuities—i.e., rotationally symmetric, uniaxial circular coaxial line sections—which are directly coupled, and each having a different impedance. More specifically, the conventional structure is often based on a stepped-impedance design which includes alternating low impedance coaxial sections 306, and high impedance coaxial sections 308. The high impedance sections 308 are formed from a thin conductor wire, while the low impedance sections 306 are formed from a thick conductor wire. In many cases, the low impedance sections 306 are filled with dielectric material 310 for further impedance reduction (e.g., polytetrafluoroethylene (PTFE)). As well, the high impedance sections 308 can be surrounded by a vacuum 312.

In conventional LPF designs, the length of each high impedance section 308 is generally defined from appropriate impedance matching conditions. Accordingly, the length of each high impedance section 308 is dependent on the design frequency, and effective electrical lengths, of adjacent low impedance sections 306. That is, the length of the high impedance sections 308 are linked by design conditions, and cannot be pre-selected.

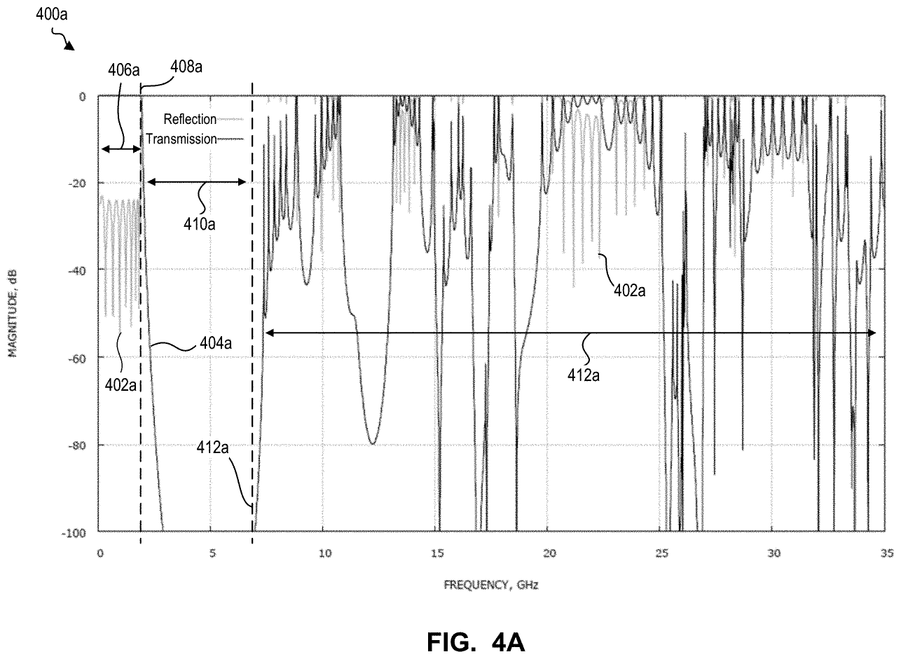

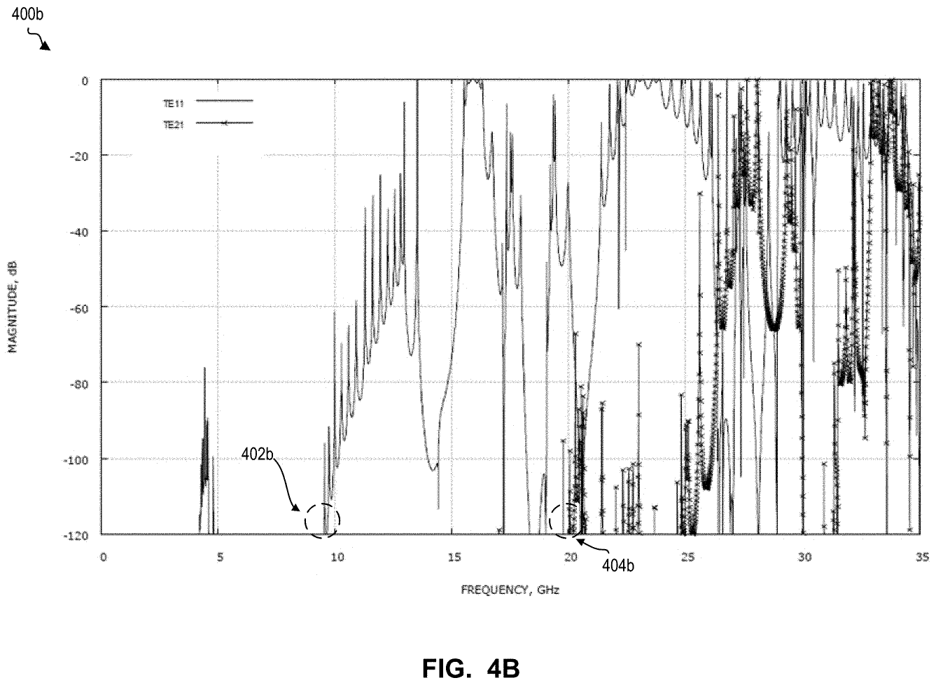

Referring now to FIG. 4A, which shows an example simulated frequency response plot 400a generated by the example conventional coaxial LPF 300 of FIGS. 3A and 3B.

In particular, the frequency plot 400a compares the reflection response 402a of the LPF structure 300, to the transmission response 404a. The frequency plot 400a is generated assuming the model coaxial filter 300 has dimensions of 24 mm (height)×24 mm (width)×215 mm (length) (e.g., height and length are expressed according to the illustration in FIG. 3B), and 2×10 mm interface 304a, 304b connectors.

As with various simulation plots provided herein, the plot 400a is generated assuming the LPF model 300 is designed to match a pass-band of frequencies between 1.1 GHz to 1.35 GHz, a stopband from 2.0 GHz to 32 GHz, as well as assuming hollow cavities (i.e., high impedance sections), Teflon (PFE) between cavities (low impedance sections) and at the interface nodes 304a, 304b. The input/output interfaces 304a, 304b in all simulated models herein also assume a threaded Neill Concelman Cable (TNC) size PTFE filled coaxial section with 1.08 mm radius, 3.62 mm external radius and 10 mm long. Further, the frequency plots are generated using a full-wave simulation tool.

Frequency plot 400a corresponds to the dominant transmission mode carried through coaxial LPF structures. More specifically, signal frequencies propagating through coaxial structures—e.g., coaxial filter 300—can be carried via different electromagnetic radiation modes (also known as waveguide modes). The dominant electromagnetic mode, which develops in coaxial cables, is the transverse electro-magnetic mode (TEM). The TEM mode is characterized by electrical and magnetic fields, of a travelling electromagnetic wave, which are each transverse to the direction of travel of the field. Plot 400a accordingly demonstrates propagation of signals carried by the dominant TEM mode.

As shown by the transmission properties 404a in the plot 400a, the “effective” passband 406a of the modeled LPF 300 extends between 0 Hz and the cut-off frequency 408a (e.g., approximately 2.0 GHz). Further, the “effective” stopband 410a extends between approximately 2.0 GHz up to approximately 7 GHz (i.e., 412a).

Of significant importance, is that the model LPF 300 fails to demonstrate effective attenuation of signal frequencies beyond 7 GHz. In other words, in contrast to the ideal LPF behavior in FIG. 2, the simulated real-implementation LPF 300 is unable to provide a high quality stopband extending to the required 32 GHz frequency point, and in turn, does not meet the common sense requirements for LPF operation.

FIG. 4A, accordingly, illustrates a first significant source of discrepancy between ideal LPF behavior, and the behavior of practical implementations of coaxial LPFs. In particular, the failure of the stopband to effectively attenuate frequencies beyond 7 GHz is a result of spurious resonances generated by the dominant TEM mode in the spurious region 412a. Spurious resonances (or spurious “resonant modes”) often result from a standing wave effect caused by mode scattering (e.g., resulting from reflection of a mode signal from boundary discontinuity). In the case of the dominant TEM mode, spurious resonances can generate a higher order TEMₙ resonant modes, wherein “n” denotes the standing-wave order (e.g., number of half-wave along the z-axis, or the length of the coaxial cable).

In the illustrated plot of FIG. 4A, the spurious resonances correspond to the higher-order TEM₁ resonant mode, which can be excited in cavities (e.g., in the larger spaces corresponding to the high impedance sections 308, or between capacitive irises), when the electrical length between junctions reach multiple wavelength halves of the TEM standing wave.

Despite the significant effect of spurious TEM resonant modes as shown in FIG. 4A, conventional LPF designs often disregard (i.e., discount) this spurious resonant effect, assuming the filter will not operate at higher frequencies.

Another significant source of discrepancy—as between theoretical LPF behavior (FIG. 2) and practical implementations of LPF coaxial designs—are signal frequencies propagated by non-dominant modes. These modes can also have a significant effect on diminishing the quality of the stopband. In particular, in addition to the dominant TEM mode, other electromagnetic modes can also exist and propagate inside coaxial structures so as to also carry signal frequencies. These modes are known as transverse electric (TE) modes and transverse magnetic (TM) modes.

The transverse electric (TE) mode is a mode characterized by an electric field that is transverse to the direction of signal propagation, and includes a magnetic field that is parallel to the propagation direction. Conversely, the transverse magnetic (TM) mode is characterized by a magnetic field that is transverse to the direction of propagation, and an electric field that is parallel to the propagation direction. There are many different “orders” of TE and TM modes, which can be resolved by solving Maxwell equations using boundary conditions on an infinite cylindrical body (e.g., modeling a cylindrical coaxial cable). The various orders of TE and TM modes are indexed with two index numbers (n, m) (e.g., TEₙₘ and TMₙₘ), wherein the first index (“n”) corresponds to an azimuthal field variation index, and the second index (“m”) is a radial field variation index. The first index (“n”) can theoretically span from zero to infinity, while the second index (“m”) can span from a value greater than zero to infinity. In general, TE and TM modes with low indices (n, m) are referred to herein as low-order modes, while TE and TM modes with higher indices are referred to herein a higher-order modes. In many cases, TE and TM modes (especially, higher order modes) are referred to as “spurious modes”, as their propagation can be undesirable in a cable.

The presence of spurious TE and TM modes inside of coaxial structures is often dependent on the respective mode cut-off frequencies. The cut-off frequency of a TM or TE waveguide mode is the frequency which excites propagation of that mode inside the coaxial cable, and is entirely separate from the filter cut-off frequency. Below the cut-off frequency of the waveguide mode, the waveguide mode is evanescent or non-propagational.

In contrast to the dominant TEM mode, which has a cut-off frequency of 0 Hz, (e.g., the TEM is able to propagate through the coaxial filter starting from 0 Hz, i.e., DC), the TE and TM modes typically have cut-off excitation frequencies which are greater than zero (0) Hz.

Table 1 provides, by way of example, cut-off frequencies for different orders of TE and TM modes, and the risk factor for these mode propagating through the coaxial cable. More specifically, Table 1 considers the first five spurious waveguide TE and TM modes which have cut-off frequencies of less than 32 GHz, and in a 50-ohm PTFE 7.2 mm (TNC ECO higher performance) cable. The cut-off frequencies in Table 1 are generally resolved by solving complex Helmholtz equations based on the particular shape, structure and design of the coaxial cable filter.

TABLE 1
Example Cut-off Frequencies for Spurious Waveguide
Modes in an Example Coaxial Cable

| Coaxial Waveguide | Cut-off | |
|---|---|---|
| Mode | Frequency, GHz | Risk Factor |
| TE₁₁ | 10.6 | High (if cable is bent) |
| TE₂₁ | 18.2 | Moderate |
| TM₀₁ | 20.8 | High (any connector or |
| | | discontinuity) |
| TE₃₁ | 21.5 | Low |
| TE₁₂ | 30.1 | Low |

In view of the foregoing, the TE and TM spurious modes can be excited, propagated and scattered if the signal frequency is equal to or greater than the cut-off frequency for that mode, and the structure, shape and design of the coaxial structure is conducive for propagation of that signal transmission mode.

As well as, similar to the TEM resonant mode, resonant TE and TM can also occur—i.e., above their respective cut-off frequency—based on a standing-wave effect. Several orders of “resonant modes” can exist, and can be indexed using the integers (m,n,l) (e.g., TMₘₙₗ, TEₘₙₗ), wherein the first two indices (m,n) correspond to the appropriate standing waveguide mode, and the third index (l) is the number of half wavelengths. The third index (l) can be zero for a TM resonant mode, but must be greater than zero for the TE resonant modes.

Referring now to FIG. 4B, which shows an example frequency response plot 400b for the example coaxial LPF structure 300 of FIG. 3, and showing the propagation of TE₁₁ and TE₂₁ spurious modes.

As shown in plot 400b, despite the example coaxial filter 300 being designed to have a stopband of between 2 GHz to at least 32 GHz, the TE₁₁ mode begins propagating starting from approximately 9 GHz (i.e., 402b), while the TE₂₁ mode begins propagating beginning from approximately 19 GHz (i.e., 404b). Accordingly, the propagation of TE and TM spurious modes compromise the quality of the filter stopband.

In particular, poor stop band quality demonstrated by conventional stepped-impedance coaxial filters (i.e., FIGS. 4A and 4B) prevent these filters from meeting the requirements of modern sensitive communication instruments, especially communication instruments which are deployed in space and aerospace applications which demand LPF designs having high stopband quality attenuation, over ultra-wide bandwidths spanning multiple harmonics.

The inability of conventional coaxial LPF structures to provide high quality stopbands is often owing to the fact that the design of these filter structures do not consider the effect of TEM resonant modes, as well as the effects of TE and TM modes (e.g., including TE and TM resonant modes). In the case of TE and TM modes, conventional designs do not assume operation at frequencies higher than the cut-off of the first TE or TM-mode in the high impedance sections, and in many cases, are often geared toward only a single dominant mode of propagation being established (e.g., the TEM mode). Accordingly, in many cases, the conventional stepped-impedance coaxial design is only effective where a single, dominant, propagation mode is established. Additionally, the structure and modelling of these filters—based on an arrangement of low and high impedance section sequences (also known as capacitive irises—formed from high-low-high impedance junctions)—result in the high impedance sections being designed to have a larger volume and length than the low impedance sections. This design, in turn, often creates conditions for spurious resonances excited by both dominant and spurious modes.

Developments and modifications in recent years, to the conventional stepped-impedance coaxial LPF structure, has not emphasized improved stopband quality of the filters, especially with regard to preventing the passing-through of spurious modes. Rather, modifications have predominantly focused on: (a) modifying the design process (e.g., new synthesis methods resulting in new response functions); (b) modification to the junctions between high and low impedance sections; (c) inserting of additional elements in the high and/or low impedance sections to move-up or attenuate spurious resonances of only the dominant TEM mode; and/or (d) modifying the external profile envelope of the coaxial LPF structure (e.g., varying internal or external radii in a tapered or stepped way, but maintaining the internal impedance in a same order).

Accordingly, the vast majority of modifications have not strayed away from the basic stepped impedance concept, and rather, focused on optimizing various electrical and mechanical performance measures.

To this end, it has been appreciated that various infeasibility problems emerge when attempting to modify conventional stepped-impedance designs to address spurious responses resulting from non-dominant modes generated in the stopband. In particular, modifying the conventional stepped-impedance design to address these spurious modes often requires employing ultra-tiny gaps in the low impedance sections filled with the PTFE (dielectric) (i.e., 310 in FIG. 3B), as well as using very thin internal wire conductors in the high impedance sections to move-up spurious responses (e.g., increase the frequency range of excitation of these spurious modes, so that they are excited at higher frequencies outside of a desired stopband range).

However, the tiny gaps and very thin wires required to realize these structures result in high power loss, low power handling, high insertion loss, technological infeasibility problems (e.g., too thin of a central wire diameter in the high impedance section, which is sensitive to tolerances and finishing), potential overheating and melting of the thin central wire, as well as maximum power peak issues (e.g., multipaction, corona and critical pressure breakdowns which can occur at high field areas in the tiny gaps inside the low impedance sections). More particularly, the reason conventional stepped-impedance coaxial LPF designs cannot be effectively designed to achieve an ultra-wide spurious-less stop-band is because these designs are often developed based on an antiquated equivalent electrical network representations (e.g., based on low/high impedance, thick iris or distributive network representations) for modelling the LPF behavior, which do not account for, and become invalid, in overmoded waveguide conditions (i.e., modelling the filter base on an ideal transmission line rather a realistic coaxial waveguide based on solving Maxwell equations to account for non-dominant modes).

In view of the foregoing, embodiments disclosed herein provide for a novel coaxial LPF structure designed to provide higher quality stopbands over wider bandwidths.

In particular, the disclosed LPF structure is able to provide an extended spurious-free stopband for TEM modes and low order TE modes than comparable coaxial LPFs (e.g., LPFs with comparable size, near-band selectivity, insertion loss and power handling). For example, at least some embodiments, the disclosed LPF design is able to provide a stopband having an attenuation of at least 50 dB for dominant and at least some spurious modes, and over at least 10 harmonics from the filter cut-off frequency. Accordingly, the provided coaxial LPF design can be suited for low frequency communication channels (i.e., channels used in sensitive space and aerospace communication systems), to remove parasitic signals which can otherwise adversely affect performance of these sensitive instruments.

The disclosed novel coaxial LPF structure also demonstrates better trade-offs between providing an ultra-wide and high quality stopband, while not significantly compromising other important LPF quality metrics (e.g., low insertion low, high power handling, high return loss, as well as desirable pass-band, roll-off and size). In particular, this allows the novel coaxial design to address requirements in recent years for communication satellite systems which are driving toward more rejection bandwidth while providing for greater power handling, which is not current effectively achieved using conventional coaxial LPF designs. Still further, as opposed to conventional LPF structures, the provided coaxial structure is able to provide an efficient design for high cut-off LPFs for low band applications, and rejection of far out-of-band frequencies in overmoding conditions.

In the context of space communication applications, as the present design is based on a filter structure with larger gaps (i.e., gaps filled with dielectric, i.e., PTFE) in the low impedance sections, the design is also less sensitive for tolerances and less vulnerable to harsh space environment than conventional designs utilizing narrow gaps.

As provided in further detail herein, the disclosed coaxial LPF structure is formed from an assembly of coaxial cavity junctions arranged sequentially by uniaxial connections. In particular, each cavity junction is pre-designed to generate at least one controlled transmission zero at specific target frequencies in a desired stopband range. A transmission zero is a frequency point when the propagation of a waveguide mode stops with the coefficient of transmission turning to zero. Each cavity junction in the LPF structure is configured to generate either two transmission zeroes at two different frequency points (e.g., closely or distally spaced frequency points), or a single transmission zero at a single frequency point (i.e., resulting from two transmission zeroes re-generating into a single transmission zero).

As disclosed in further detail herein, the frequency locations of the transmission zeroes, generated by each cavity junction in the LPF structure, is controlled by adjusting design parameters of the cavity junctions (e.g., internal dimensions and fillings). For example, in a chain of cavity junctions—each cavity junction can be pre-designed to generate transmission zeroes at different frequency points. Accordingly, by connecting (e.g., cascading) a chain of variably designed cavity junctions—the transmission zeroes, generated by the collective of all cavity junctions in the chain—is a scattering of transmission zeros generated by each cavity junction individually. In various embodiments, this allows the chain of junctions (i.e., a periodic or quasi-periodic chain) to be configured to scatter transmission zeroes within the desired LPF stopband bandwidth, thereby generating a region of zero transmission (i.e., the stopband). By varying the design of the cavity junctions in the chain, an LPF structure can be flexibly designed to generate a range of desired stopbands by adjusting the corresponding scattering of the transmission zeroes generated by each individual cavity junction.

In view of the foregoing, the provided coaxial LPF design is functionality dissimilar from conventional coaxial LPF structures. In particular, conventional LPF designs do not allow for designing controlled transmission zeroes within a desired stopband range using cascaded cavity junctions as building block elements of the LPF structure. Rather, the elementary building material used in conventional filters are impedance steps, coaxial disc capacitors and/or capacitive irises. These traditional elements do not generally perform controlled transmission zeroes if simulated over a frequency domain, and do not demonstrate as improved performance for narrow band applications with additional broadband rejection requirements. Additionally, the provided coaxial LPF structure differs from conventional LPF structures in that it is based on a periodic or quasi-periodic structure, rather than a distributed design.

Still further, in contrast to conventional designs, the cavity junctions in the provided coaxial LPF structure are not modeled based on low/high impedance sections (e.g., impedance being defined as the voltage to current density ratio (V/J)—which cannot be used to model TE and TM modes). Rather, it is appreciated that the TE and TM modes are commonly associated with electric field to magnetic field ratio (E/H), which is expressed as wave impedance. As provided herein, the cavity junctions are accordingly expressed in terms of wave impedances (admittances) to account for TE and TM propagation.

As provided in still further detail herein, the cavity junctions—forming the elementary constituent elements of the disclosed novel LPF structure—are broadly categorized as one of two types: type “A” cavity junctions, and type “B” cavity junctions.

Type “A” cavity junctions are dual-mode cavity junctions which generate transmission zeroes based on TEM₁ and TM₀₁₀ coupled resonances. In various applications, type “A” cavity junctions can be used to generate transmission zeroes in a near stop-band range, and therefore may be ideally suited for building low cut-off LPF structures.

In contrast, type “B” cavity junctions are dual-mode cavity junctions which generate transmission zeroes based on TEM₁ and TM₀₂₀ coupled resonant modes (i.e., the TM₀₁₀ spurious resonant mode being removed). In general, type “B” cavity junctions can generate transmission zeroes in a far stop-band range, and therefore may be suited for building high cut-off LPF structures.

In particular, the disclosed dual-mode cavity junctions generate transmission zeroes by achieving special conditions to allow the dominant TEM mode to excite TEM₁ and TM₀₁₀ or TEM₁ and TEM₀₁₀ coupled resonances. Accordingly, in this manner, variously configured type “A” and/or type “B” cavity junctions can be arranged (e.g., cascaded) in a period or quasi-periodic (i.e., period varies over length of chain) sequence, such as to scatter (e.g., distribute) the transmission zeroes generated by the TEM₁ and TM₀₁₀/TM₀₂₀ coupled resonances within a target stopband range, thereby generating an ultra-wide and spurious-less stop-band as with respect to at least the TEM mode by utilization of the TEM₁, TM₀₁₀ and TM₀₂₀ resonances.

The disclosed cavity junctions are designed to predominantly stop propagation of spurious TEM and low-order TM₀₁, TM₀₂ modes. In particular, the focus on these specific modes is owing to the rotational symmetry of the cavity junctions, which do not typically excite other higher-order waveguide modes, except for TEM, as well as low-order TM_{0M}-group of modes, which are strongly coupled with the dominant TEM mode. In particular, higher-order TM modes are typically evanescent in coaxial structures (i.e., non-propagating), while all TE modes are not typically excited by the TEM mode as they have a different field structure symmetry. Further, while low order TE_{0N} may be excitable in coaxial structure based on certain excitation conditions, they may cause resonances which are not as easily removed.

1. Overview of Cavity Junction Structure

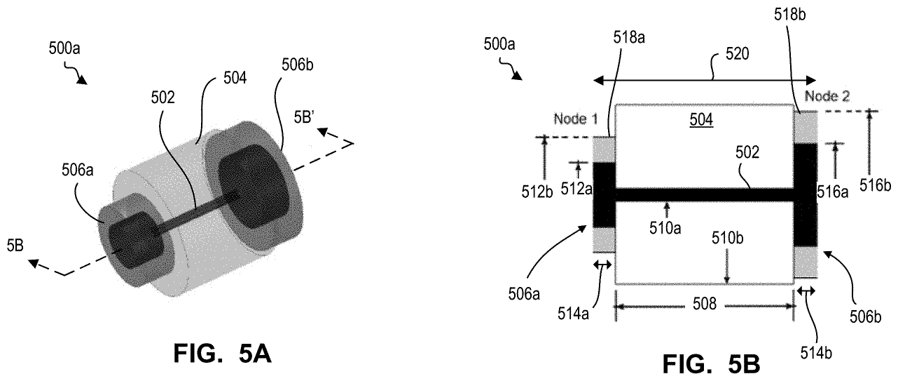

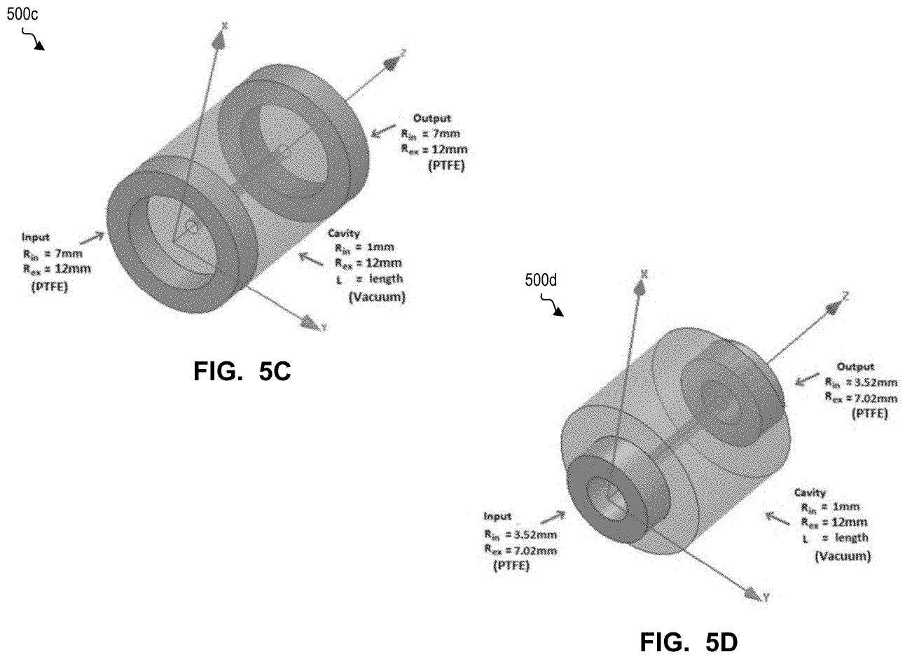

Referring now to FIGS. 5A and 5B, which show an example coaxial cavity junction 500a, in accordance with embodiments provided herein. The example cavity junction 500a may be configured as a type “A” cavity junction or a type “B” cavity junction. As explained herein, one or more cavity junctions—similar to cavity junction 500a—can be connected (e.g., cascaded) in series to form the disclosed coaxial LPF structure.

As shown, the exemplified cavity junction 500a is a uniaxial and rotationally symmetric junction. In other embodiments, however, the same principles—which inform operation of these junctions—can apply to other shapes and configurations of cavity junctions.

In the illustrated embodiment, cavity junction 500a includes an internal conductor wire 502 located inside of a cavity 504, and extending between a first node 506a and a second node 506b (e.g., input and output nodes). The cavity junction 500a is formed by a larger cavity section 504 connected to two coaxial lines of smaller cross-section (i.e., nodes 506a, 506b) at both ends. In particular, as used herein, a cavity (e.g., cavity 504) is a section of the coaxial LPF line having a larger cross-section (e.g., a large external radius, and a large ratio to the internal radius) than the remaining portion of the junction. In some cases, the cavity is a hollowized portion (i.e., includes a vacuum), but in other cases, it can also be filled completely or partially filled with dielectrics (e.g., PTFE).

Nodes (e.g., 506a, 506b) are coaxial line sections having a smaller relative cross-section (e.g., the ratio of the external and internal radii is smaller) in comparison to the cavity 504 it is connected to. In various cases, the nodes can have an insignificant ration between the external and internal radii. In some cases, the nodes 506 are filled with dielectrics (PTFE) 518a, 518b, however in other cases the nodes can be hollow.

As shown in FIG. 5B, the physical structure of a cavity junction 500a may be expressed by a number of geometric (or physical) parameters. For example, the cavity portion 504 has a cavity length (L) 508, an internal cavity radius (Rᵢₙ) 510a and external cavity radius (Rex) 510b, wherein the internal and external radii are defined around the internal conductor 502.

As well, the first node 506a may be expressed as having a first internal radius (rᵢₙ⁽¹⁾) 512a for the internal conductor 502, a first external radius (rₑₓ⁽¹⁾) 512b for the dielectric filling 518a (or in some cases a vacuum non-filling), as well as a first distance length (dᵣ⁽¹⁾) 514a. Similarly, the second node 506b may also have an internal radius (rᵢₙ⁽²⁾) 516a for the internal conductor 502, an external radius (rₑₓ⁽²⁾) 516b for the dielectric/vacuum 518b, and a distance length (dᵣ⁽²⁾) 514b. The total length 520 of the cavity junction 500a (d) is then approximately the sum of the cavity length 508 and the node distance lengths 514a, 514b (e.g., d=dᵣ⁽¹⁾+dᵣ⁽²⁾+L).

While the cavity junction in FIG. 5A is illustrated as being uniaxial and rotationally symmetric, in other cases, the cavity junctions of the provided coaxial LPF structure can be distorted or reshaped without significant change to the junction's basic properties. For example, the internal and external conductors can change cross-sections within the line portions and have humps, dents or round corners. Further, the filling materials can have more complex compositions, and intrude or extrude from the appropriate line sections. In particular, these changes are considered as insignificant “perturbations”, and do not vary the basic principles of cavity junction operation.

As explained in further detail below, it has been appreciated that the physical (i.e., structure or geometric) dimensions of the basic cavity junction unit 500a can be adjusted to generate different types of transmission zeroes at select frequencies. In particular, as provided herein, the cavity junction 500a can be structurally configured such as to generate two types of junction operation modes: (a) a first type of cavity junction which generates transmission zeroes caused by a dual-mode coupling when the dominant mode TEM excites TEM₁ and TM₀₁₀ coupled resonances (also referred to herein as type “A” cavity junctions); and (b) a second type of cavity junction which generates transmission zeroes caused by a dual-mode coupling when the dominant TEM mode excites TEM₁ and TM₀₂₀ coupled resonances (also referred to herein as type “B” cavity junctions). As explained herein, type “A” cavity junctions can be generally used for constructing low cut-off LPFs, while type “B” cavity junctions can be used for constructing high cut-off LPFs. In this manner, the appropriate cavity junction can be deployed based on the desired requirements of the LPF design.

(a) Type “A” Cavity Junctions—Low Frequency Transmission Zero Cavity Junctions

As provided in further detail herein with reference to electromagnetic approximation models, the basic cavity junction 500a of FIGS. 5A and 5B is configurable to generate transmission zeroes caused by a dual-mode coupling when the dominant mode TEM excites TEM₁ and TM₀₁₀ coupled resonances. As the transmission zeroes generated by type “A” cavity junctions occur at relatively lower frequencies (e.g., 5 GHz to 20 GHz), type “A” junctions may be used for constructing low cut-off LPFs (i.e., low-pass filters with roll-offs starting at relatively low frequencies (i.e., when the wavelength is much greater than the diameter of the channel, e.g., 3 times or more)).

In various cases, owing to the field geometry of the TEM₁ and TM₀₁₀ resonant modes, type “A” cavity junctions include a sufficiently large cavity radius (e.g., subtracting the internal cavity radius (Rᵢₙ) 510a from the external cavity radius (Rex) 510b), and a sufficiently short cavity length 508 to resonate the TM₀₁₀ resonance, and also couple it with TEM₁ resonance. In various cases, the TEM₁ resonant mode can develop when the cavity length 508 fits approximately a half-wavelength, and the TM₀₁₀ mode can develop when the radial dimension of the cavity fits a half-wavelength. In some cases, type “A” cavity junctions have a cavity length 508 that is approximately equal to the cavity radial length. In some embodiments, the type “A” cavity junctions include input and output nodes (e.g., 506a, 506b) which are more proximal to the external or internal conductors, as these positions better excite the TM₀₁₀ resonances.

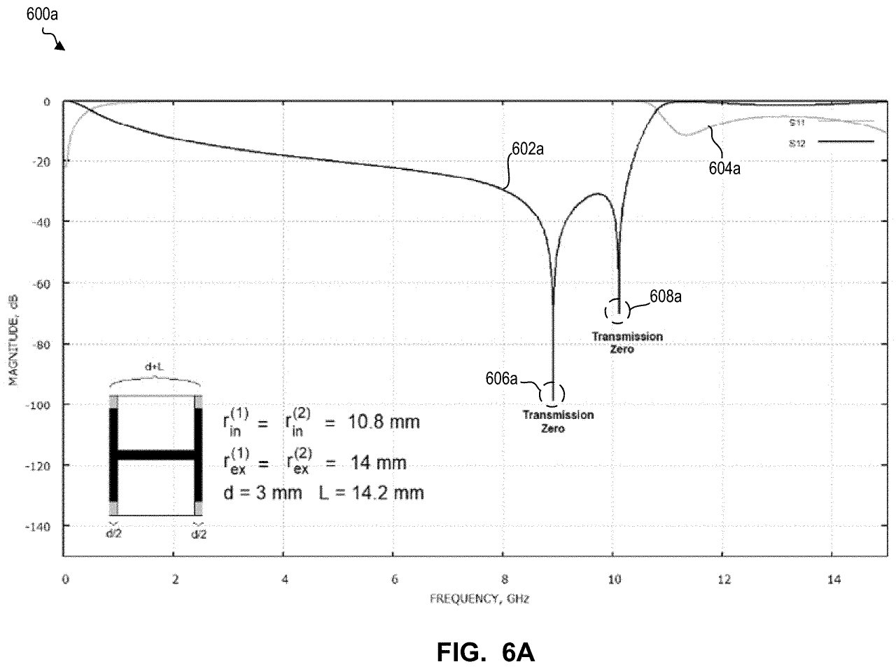

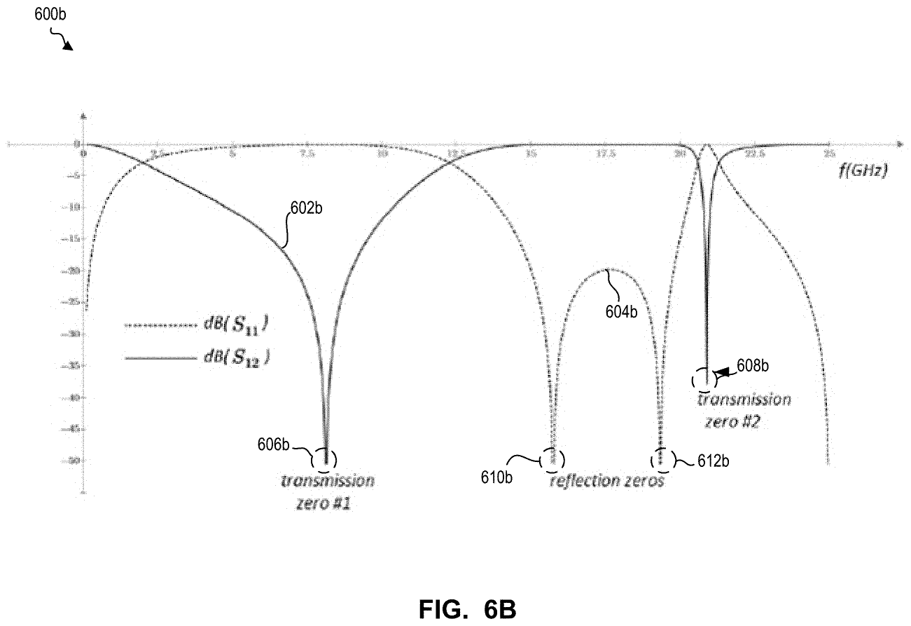

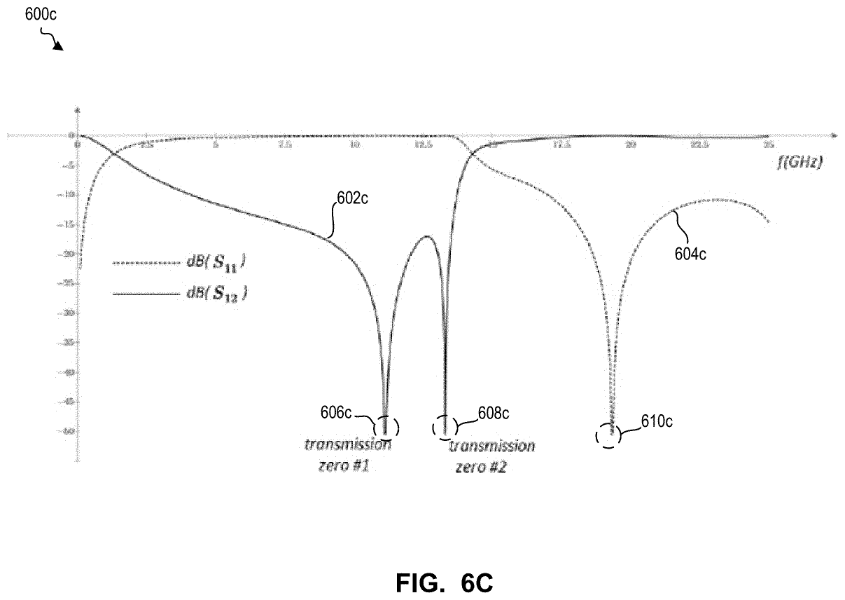

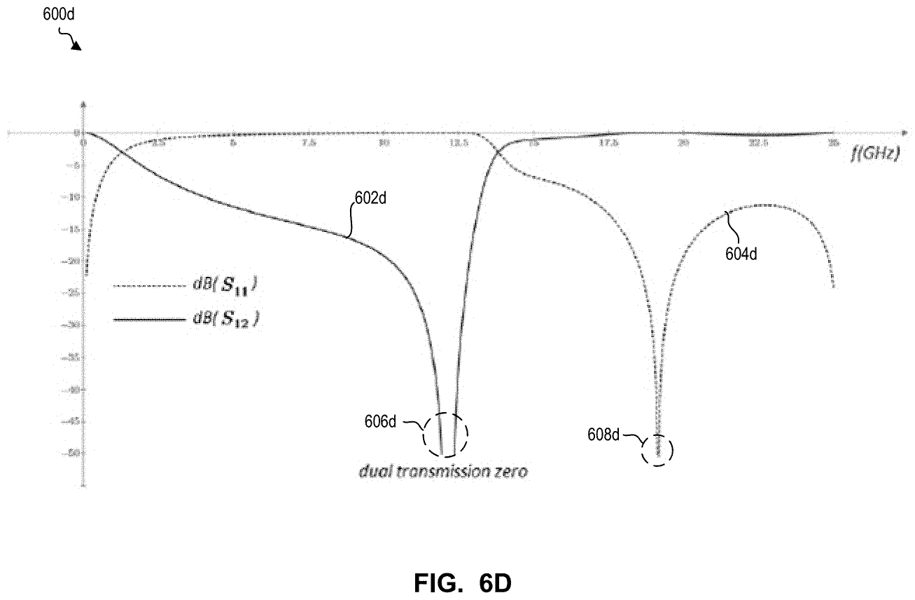

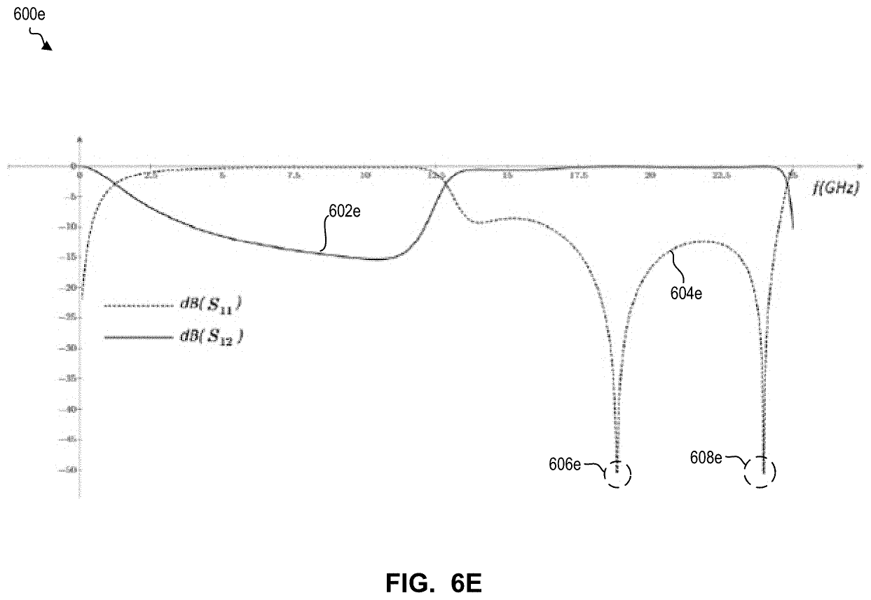

Referring now to FIG. 6A, which shows an example frequency response plot 600a generated by an example type “A” cavity junction for the TEM mode, and illustrating the reflection properties 602a versus the transmission properties 604a of the example type “A” cavity junction.

In particular, the plot 600a is generated based on an example symmetric junction having first and second node internal radii (rᵢₙ⁽¹⁾ and rᵢₙ⁽²⁾) 512a, 516a of 10.8 mm, first and second node external radii (rₑₓ⁽¹⁾, rₑₓ⁽²⁾) 512b, 516b of 14 mm, a cavity length (L) 508 of 14.2 mm, and a total cavity junction length (d) 516 of 14.5 mm. As shown in the transmission response 602a, the example simulated type “A” cavity junction is configurable to generate transmission zeroes 606a, 608a at select frequencies of approximately 9 GHz and 10 GHz, which correspond to TM₀₁₀ and TEM₁ coupled resonances.

As explained in greater detail herein with reference to electromagnetic models, in order to vary the position of transmission zeroes to desired target frequencies, aspects of the structural geometry of the cavity junction can be re-configured (e.g., the length and diameter). Additionally, aspects of the structural geometry of the cavity junction can also be configured to generate different types of low frequency transmission zeroes (e.g., highly-spaced apart transmission zeroes, closely-spaced apart transmission zeroes or a single re-generated transmission zero).

To illustrate the latter concept, FIG. 5C shows another embodiment of a type “A” cavity junction 500c. In this example cavity junction, the internal radii of the first and ((2 second nodes (rᵢₙ⁽¹⁾ and rᵢₙ⁽²⁾) 512a, 516a are each 7 mm, the external radii of the first and second nodes (rₑₓ⁽¹⁾, rₑₓ⁽²⁾) 512b, 516b are each 12 mm, the cavity internal radius (Rᵢₙ) 510a is 1 mm and the cavity external radius (Rₑₓ) is 12 mm. In particular, as illustrated in FIGS. 6C-6D, the cavity length (L) 508 may be varied to generate different types of low-frequency transmission zeroes.

Referring now to FIGS. 6B to 6D, which illustrate various types of transmission zeroes which are generated by varying the cavity length (L) 508 of the example cavity junction 500c.

FIG. 6B shows an example frequency response plot 600b generated using a simulated cavity length (L) 508 of 7.5 mm for the cavity junction 500c, and plotting transmission properties 602b versus reflection properties 604b. As shown by the transmission properties 602b, a cavity length 508 of 7.5 mm generates two highly-spaced apart transmission zeroes 606b, 608b at approximately 16 GHz and 19 GHz. As well, two reflection zeroes 610b, 612b are also generated between the transmission zeroes (e.g., a frequency point in which the waveguide mode is transmitted with no reflections).

FIG. 6C shows an example frequency response plot 600c generated using a simulated cavity length (L) 508 of 11.5 mm for the cavity junction 500c, and plotting transmission properties 602c versus reflection properties 604c. As shown by the transmission properties 602c, two closely spaced transmission zeroes 606c, 608c are now generated at approximately 11 GHz and 13 GHz. Further, a single reflection zeroes 610c is observed in the plot 600c.

FIG. 6D is an example frequency response plot 600d generated using a simulated cavity length 508 (L) of 11.76 mm for the cavity junction 500c, and plotting the transmission properties 602d versus reflection properties 604d. As shown by the transmission properties 602d, two transmission zeroes are regenerated into a single transmission zero 606d at approximately 12 GHz. Further, a single reflection zeroes 608d is also observed in the plot 600d.

FIG. 6E shows an example frequency response plot 600e which is generated using a simulated cavity length 508 (L) of 13 mm, and plotting the transmission properties 602e versus reflection properties 604e. As shown in this case, no transmission zeroes are generated, while only two reflection zeroes 606e, 608e are generated.

A further explanation of how the cavity length can be varied to generate different types of transmission zeroes using type “A” cavity junctions is provided in further detail herein with reference to electromagnetic approximation models of these types of cavity junctions.

(b) Type “B” Cavity Junctions—High Frequency Transmission Zero Cavity Junctions

The basic cavity junction 500a can also be configured as a type “B” junction which generates transmission zeroes caused by a dual-mode coupling when the dominant mode TEM excites TEM₁ and TM₀₂₀ coupled resonances. In this case, the TM₀₁₀ excitation is removed, and the scattering response is extended to the TM₀₂₀ cut-off. As explained in further detail herein within reference to approximated electromagnetic models, the TM₀₁₀ resonance is removed and the TM₀₂₀ resonance is introduced in type “B” cavity junctions with appropriate junction geometry.

In various cases, type “B” cavity junctions have a cavity length 508 that is approximately twice as short as the radial length (e.g., subtracting the internal cavity radius (Rᵢₙ) 510a from the external cavity radius (Rₑₓ) 510b), to allow for TEM₁ and TM₀₂₀ coupled resonances. The TEM₁ resonant mode can develop when the cavity length 508 fits a half-wavelength, and the TM₀₂₀ resonance frequency can develop when a full wavelength fits the radial dimension. In some embodiments, the type “B” cavity junctions can include input and output nodes (e.g., 506a, 506b) which are located about a median circle line of the cavity (in some cases, slightly shifted closer to inner conductor 502) as such a position does not excite TM₀₁₀ resonances, and only excites the TM₀₂₀ resonances.

The transmission zeroes generated by type “B” cavity junctions are generally generated at relatively higher frequencies (e.g., 20 GHz to 40 GHz). In particular, type “B” cavity junctions are generally able to generate transmission zeroes located at roughly twice as high frequency as type “A” cavity junctions, and accordingly can be used to scatter transmission zeroes in far-range stopbands. As explained in further detail herein, this property of type “B” cavity junctions can allow these cavity junctions to be used for implementing high cut-off LPFs (i.e., LPFs with roll-offs starting at relatively high frequencies (e.g., when the wavelength is smaller or comparable to the diameter of the channel (i.e., less than 3 diameters)).

Referring now to FIG. 5D, which illustrates an example embodiment of a type

“B” cavity junction 500d. In this example cavity junction, the internal radii of the first and second nodes (rᵢₙ⁽¹⁾ and rᵢₙ⁽²⁾) 512a, 516a are each 3.52 mm, the external radii of the first and second nodes (rₑₓ⁽¹⁾, rₑₓ⁽²⁾) 512b, 516b are each 7.02 mm, the cavity internal radius (Rᵢₙ) 510a is 1 mm and the cavity external radius (Rₑₓ) is 12 mm. Similar to the exemplified type “A” cavity junctions, the cavity length (L) 508 may be varied to generate different types of high-frequency transmission zeroes.

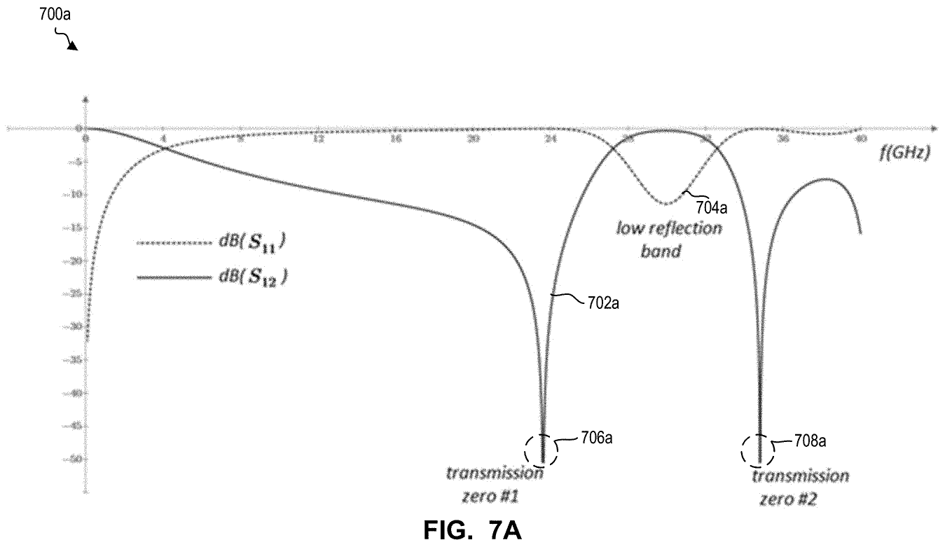

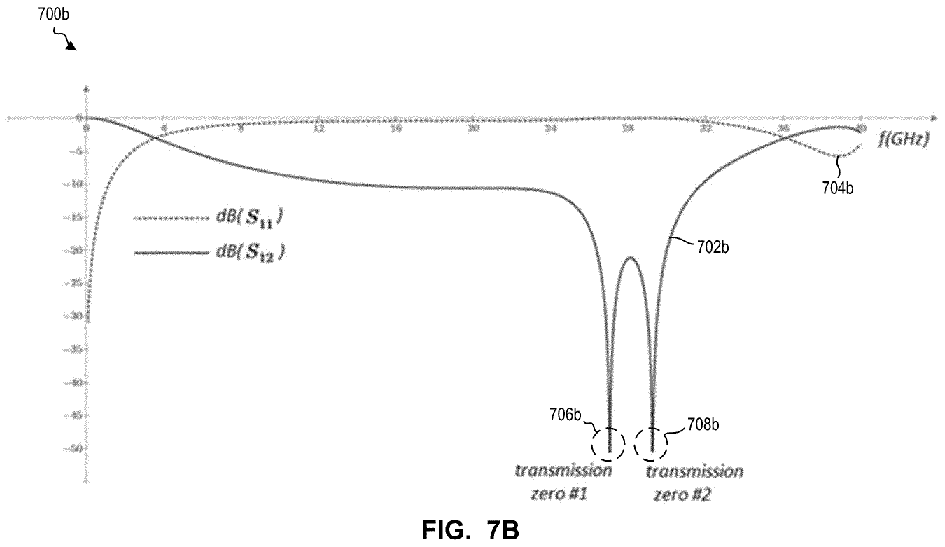

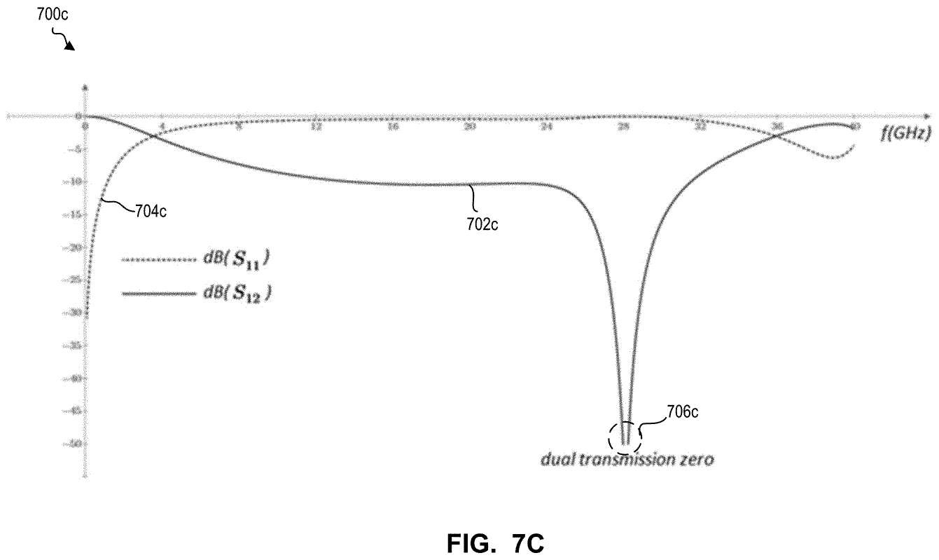

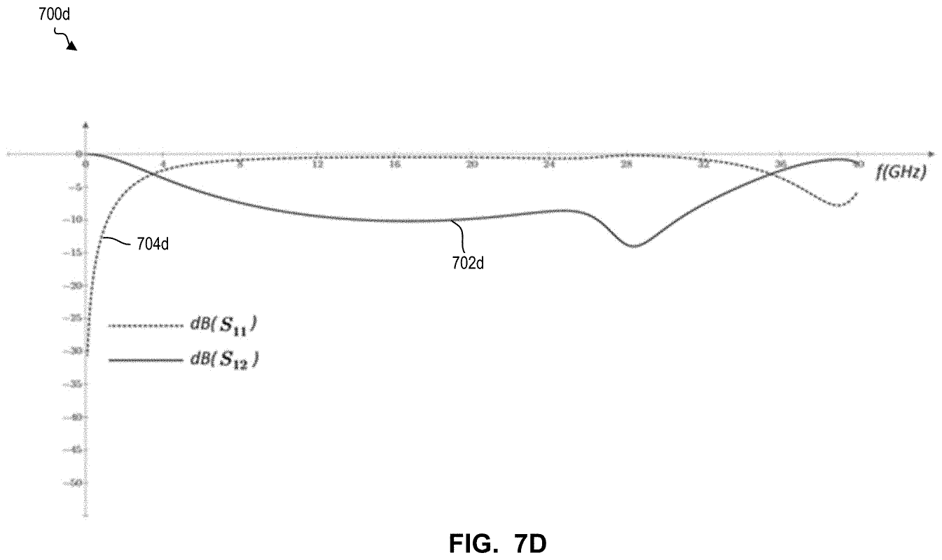

Referring now to FIGS. 7A to 7D, which illustrate various types of transmission zeroes generated by varying the cavity length (L) 508 of the example type “B” cavity junction 500d.

FIG. 7A shows an example frequency response plot 700a generated using a simulated cavity length 508 of 4.9 mm for the cavity junction 500d, and plotting transmission properties 702a versus reflection properties 704a. As shown by the transmission properties 702a, a cavity length 508 of 4.9 mm generates two highly-spaced apart transmission zeroes 706a, 708a at approximately 23 GHz and 35 GHz.

FIG. 7B shows an example frequency response plot 700b generated using a simulated cavity length 508 of 5.65 mm for the cavity junction 500d, and plotting transmission properties 702b versus reflection properties 704b. As shown by the transmission properties 702b, a cavity length 508 of 5.65 mm generates two closely-spaced apart transmission zeroes 706b, 708b at approximately 27 GHz and 29 GHz.

FIG. 7C shows an example frequency response plot 700c generated using a simulated cavity length 508 of 5.695 mm for the cavity junction 500d, and plotting transmission properties 702c versus reflection properties 704c. As shown by the transmission properties 702c, a cavity length 508 of 5.695 mm generates two transmission zeroes regenerated into a single transmission zero 706c at approximately 28 GHz.

FIG. 7D shows an example frequency response plot 700d generated using a simulated cavity length 508 of 5.8 mm for the cavity junction 500d, and plotting transmission properties 702d versus reflection properties 704d. As shown by the transmission properties 702d, a cavity length 508 of 5.8 mm generates no transmission zeroes.

A further explanation of how the cavity length can be varied to generate different types and locations of transmission zeroes using type “B” cavity junctions is also provided in further detail herein with reference to electromagnetic approximation models of these cavity junctions.

2. Low-Pass Filter (LPF) Structures Formed by Periodic or Quasi-Periodic Repetition of Cavity Junctions

As explained herein, type “A” and type “B” cavity junctions may be cascaded in periodic or quasi-periodic chain sequences in order to scatter transmission zeroes—generated by each cavity junction—in a desired stopband range, and in turn, form a low-pass filter response.

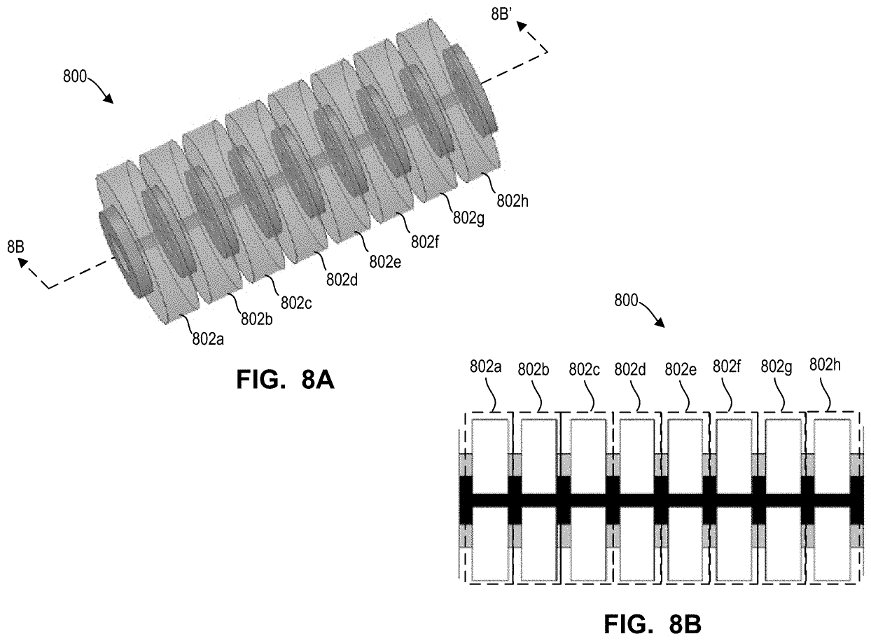

For example, referring to FIGS. 8A and 8B, which schematically illustrate an example LPF structure 800 formed from a plurality of cavity junctions (e.g., cavity junctions 500a) 802a-802h. For ease of exposition, the LPF structure 800 is illustrated with eight cavity junctions, however it will be appreciated that any number of cavity junctions can be combined to form the LPF structure 800.

In particular, in contrast to conventional LPF structures (e.g., stepped-impedance coaxial LPFs based on a common lumped or distributive order), as provided herein, the disclosed LPF design demonstrates high quality, extended spurious-free stopbands at a large range of desired frequency ranges owing to the configurable nature of the cavity junctions forming the disclosed LPF structure, which generate controlled and adjustable transmission zeroes at desired frequency points.

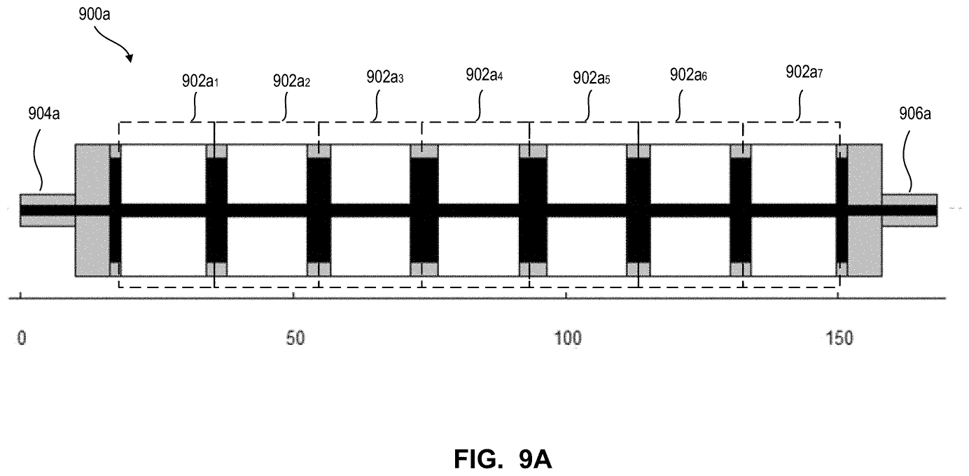

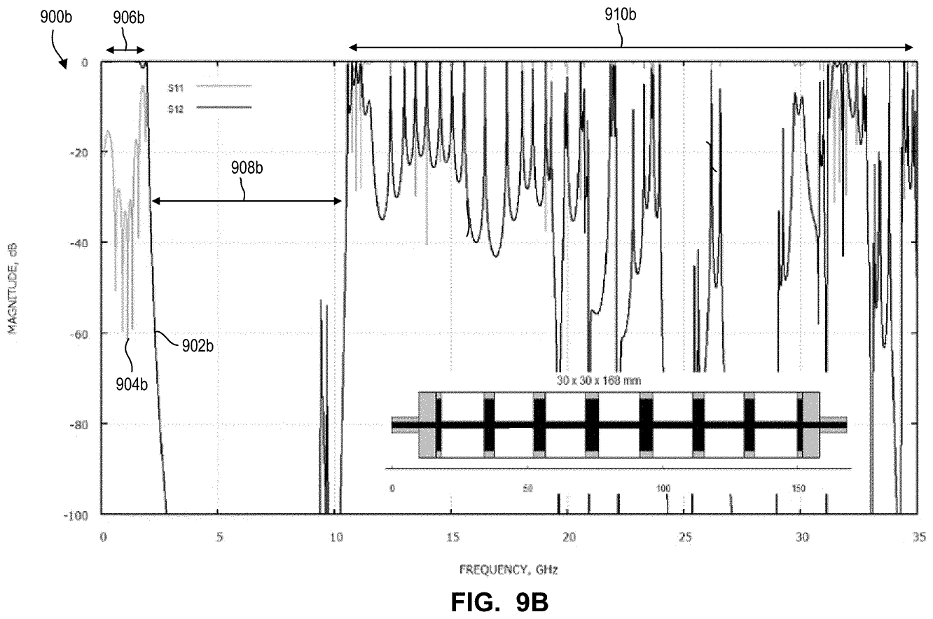

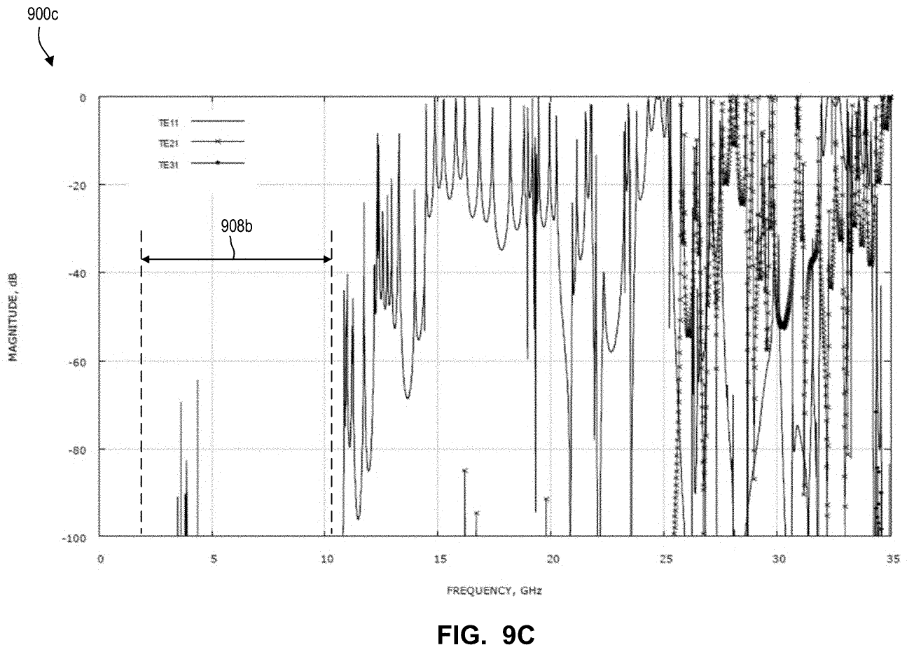

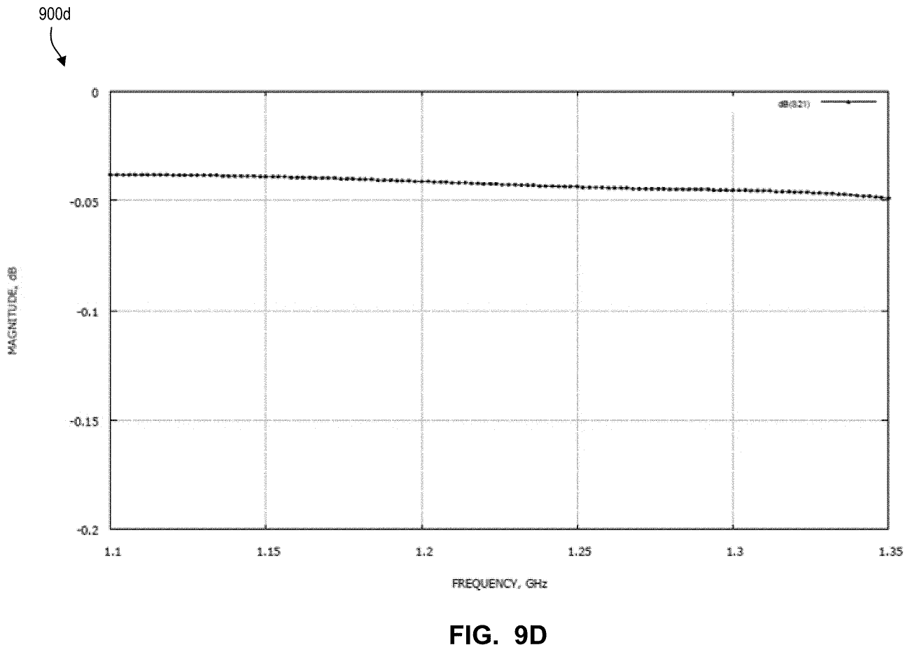

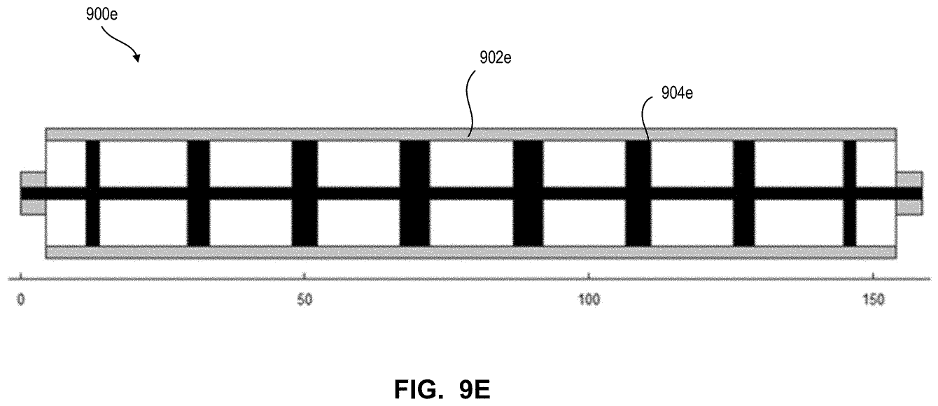

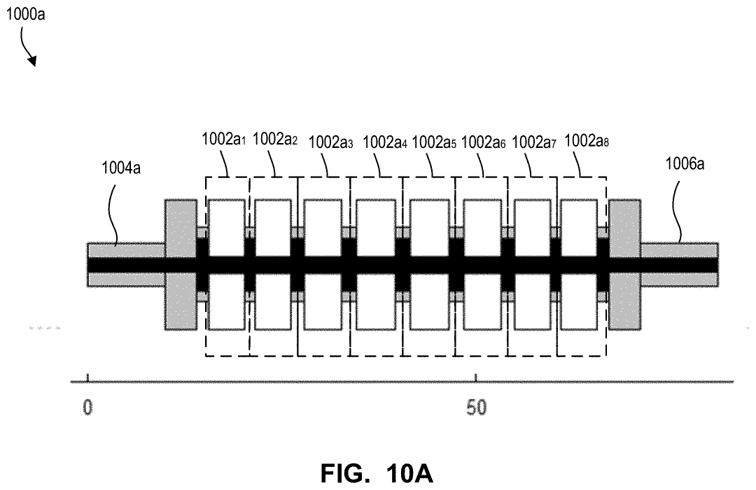

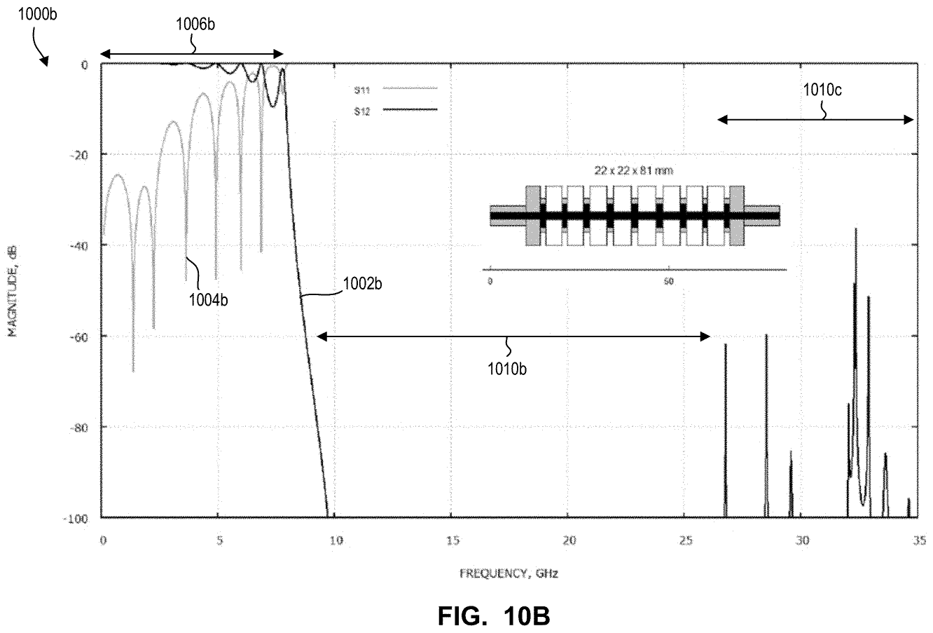

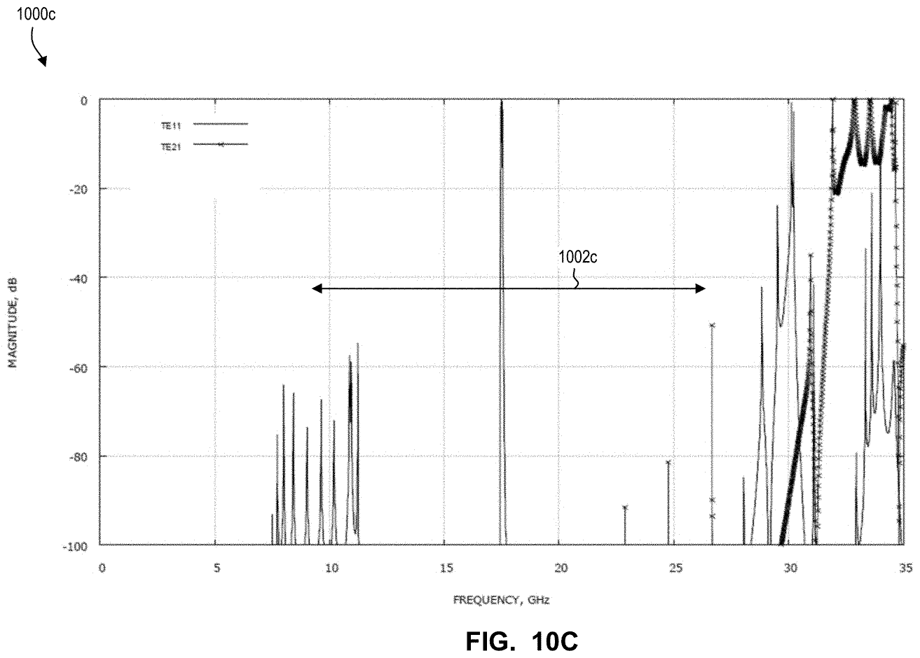

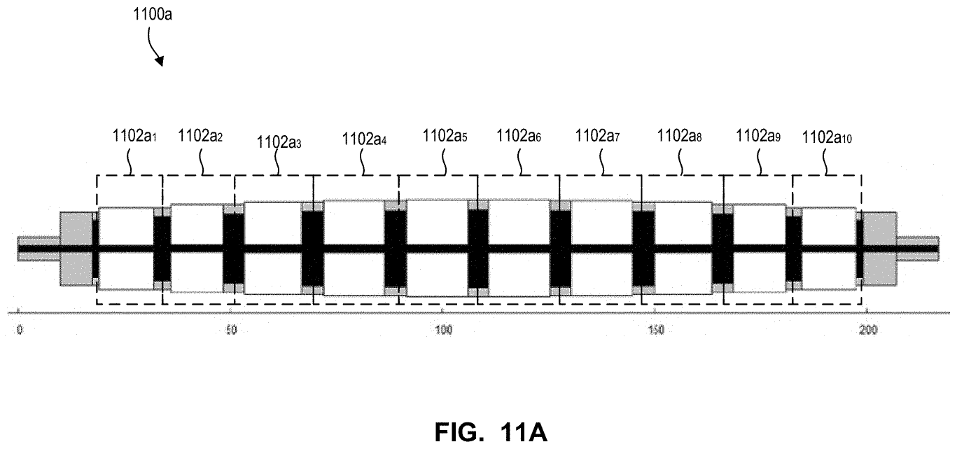

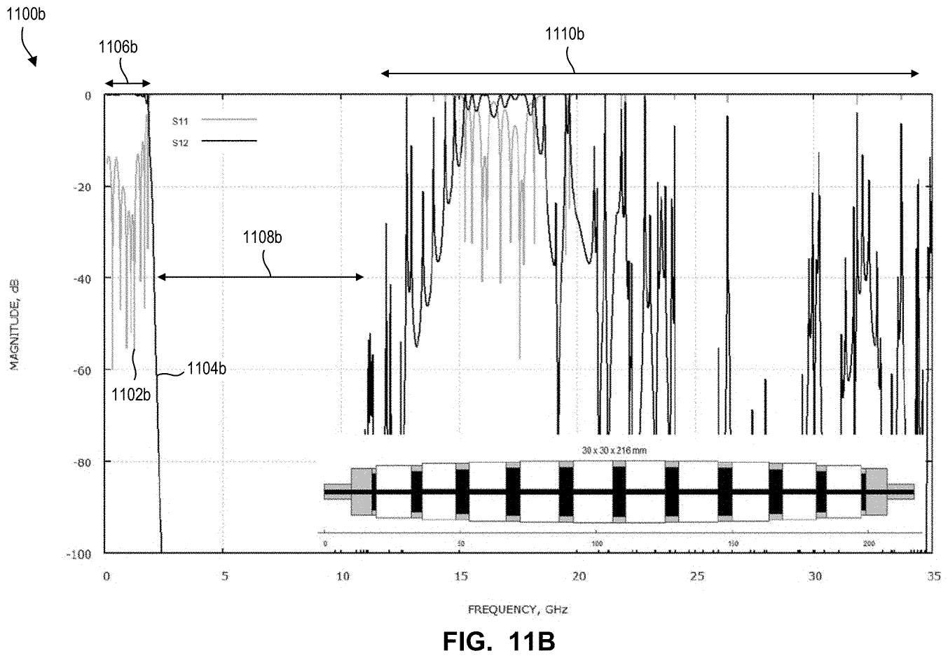

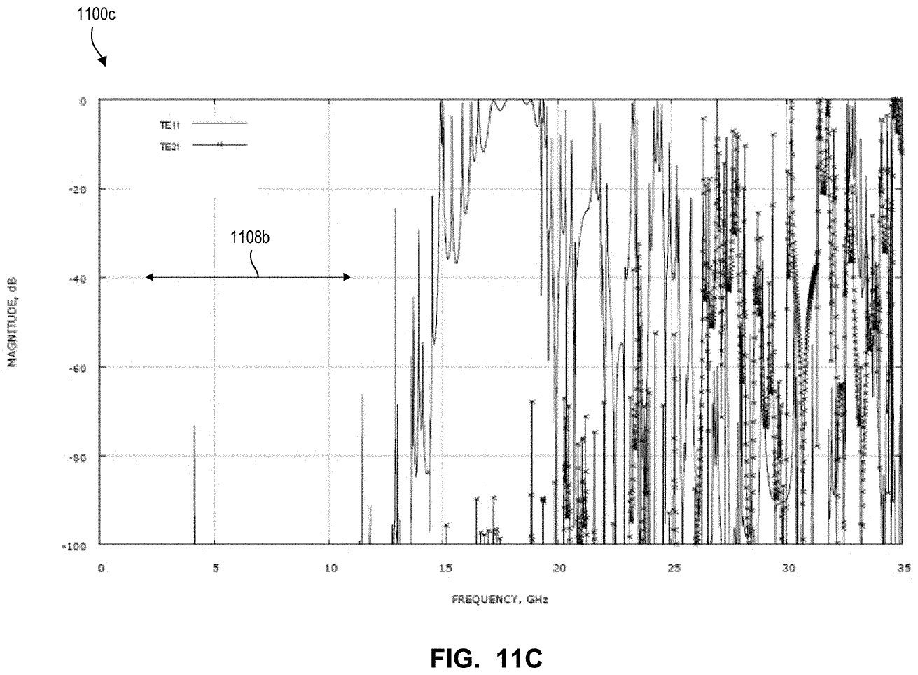

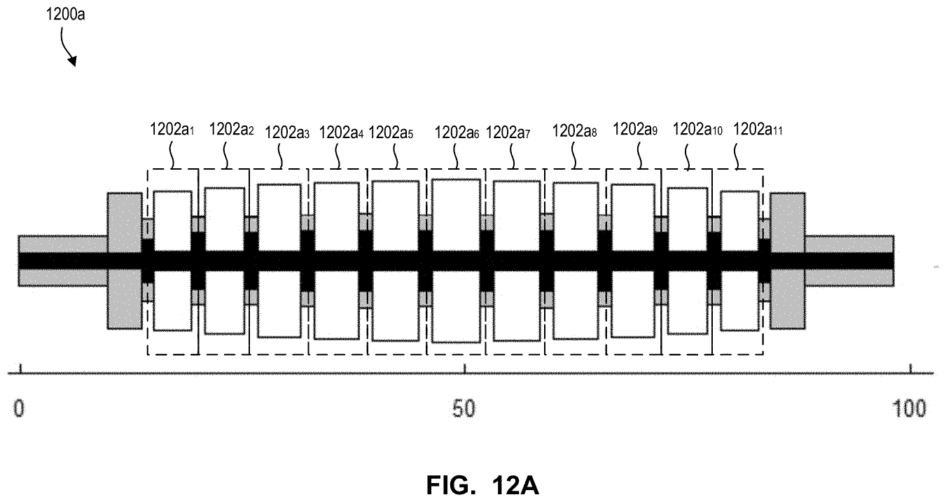

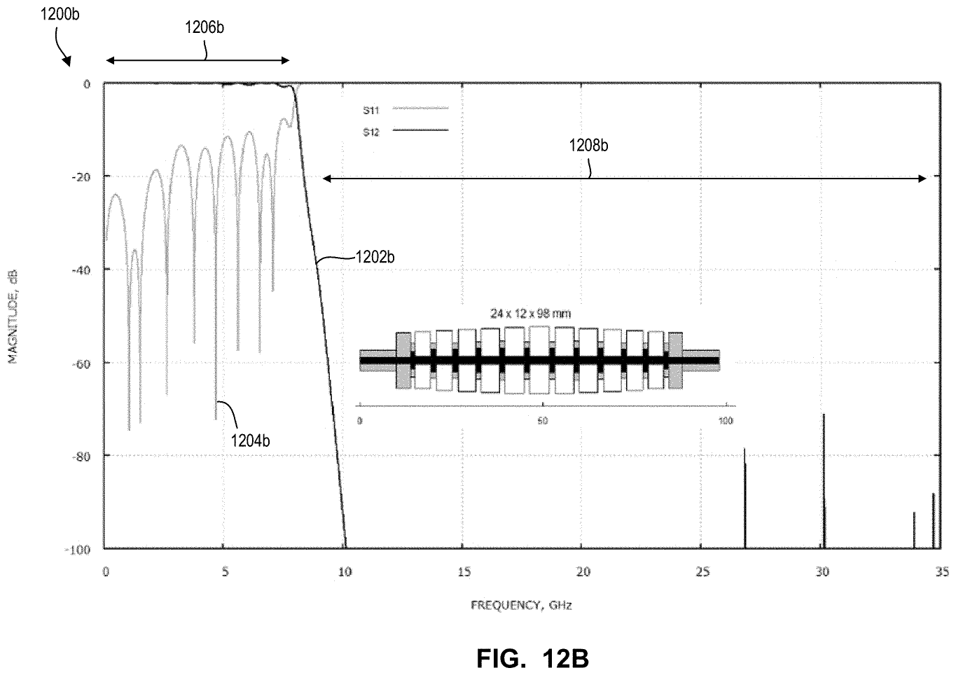

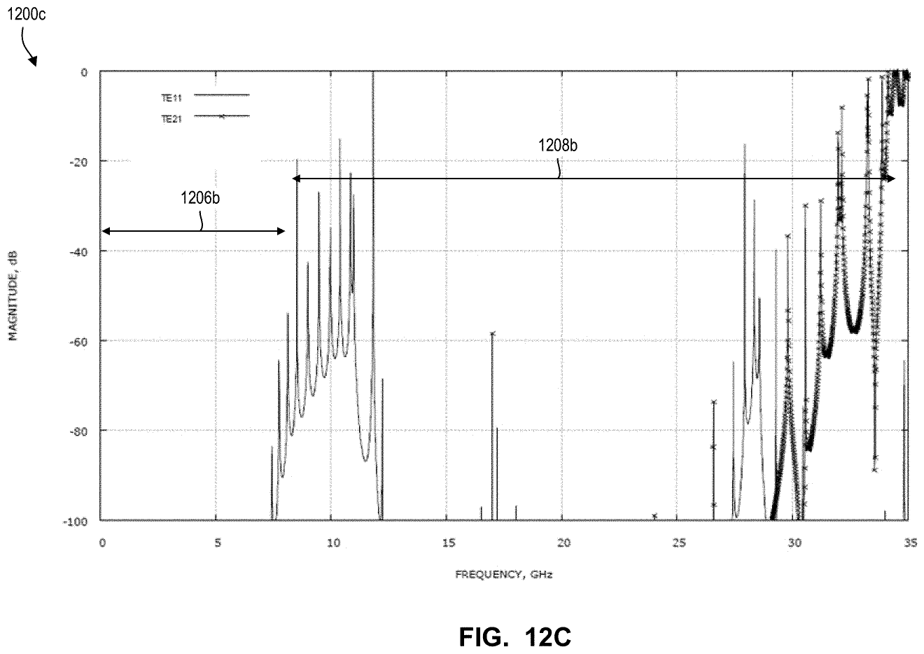

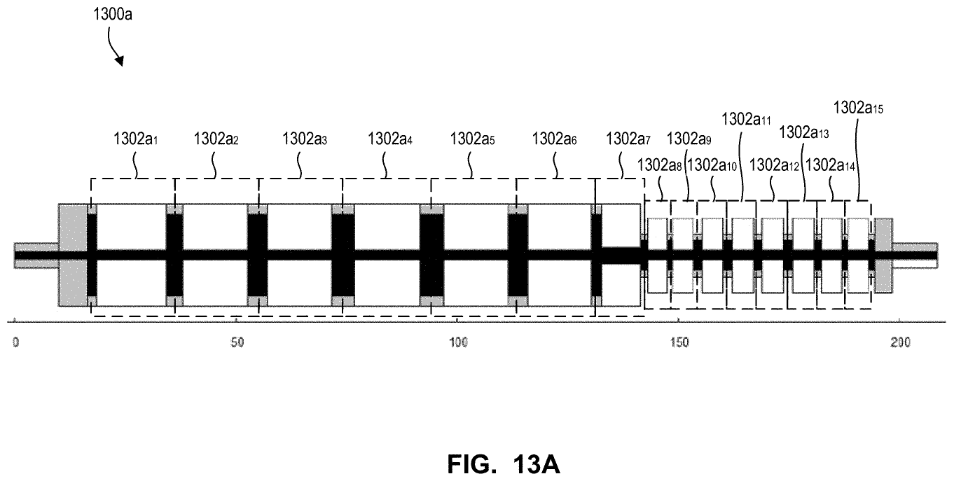

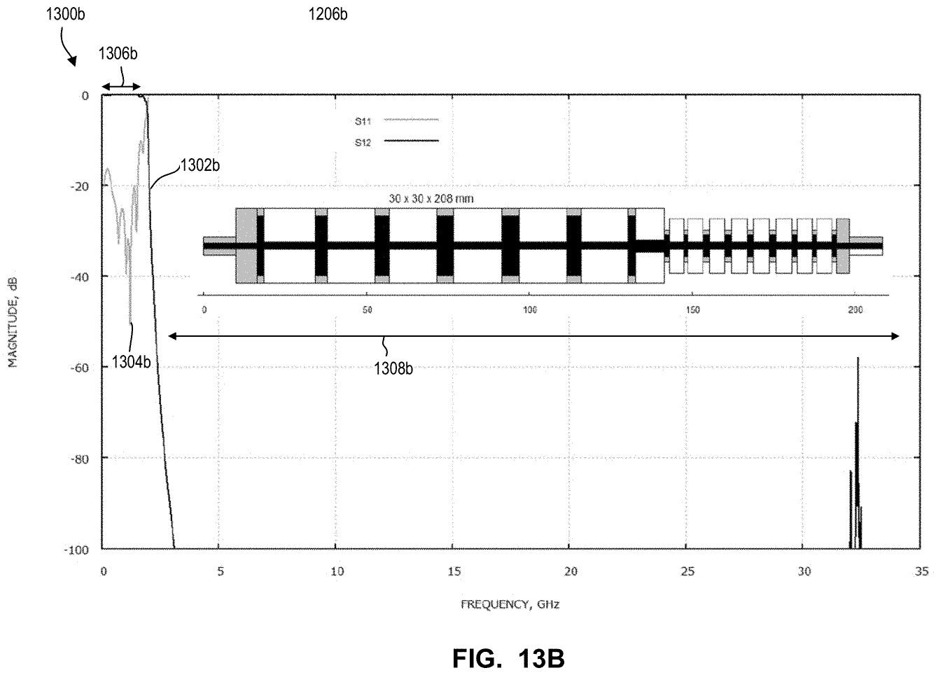

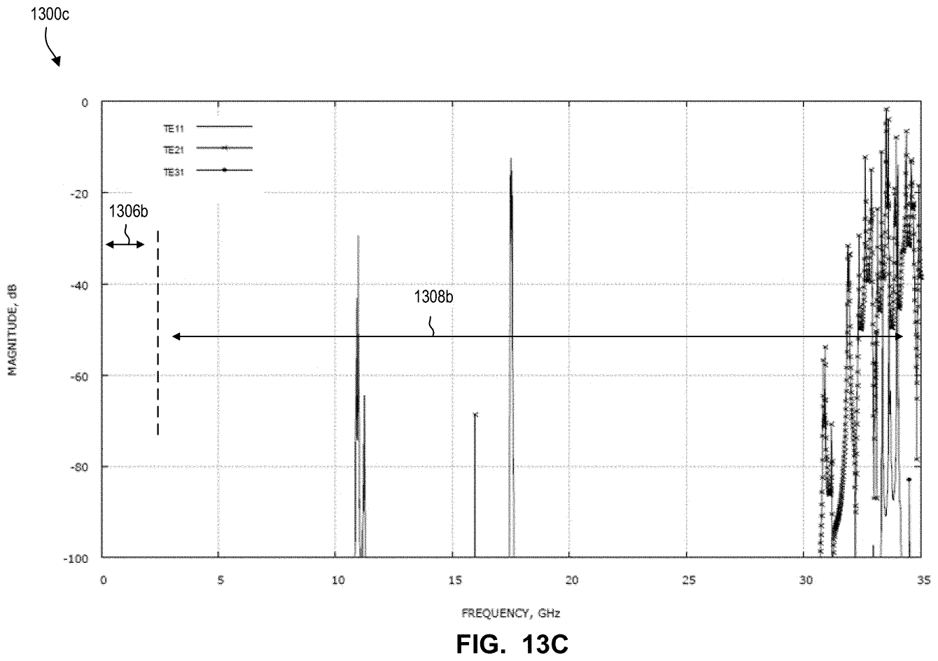

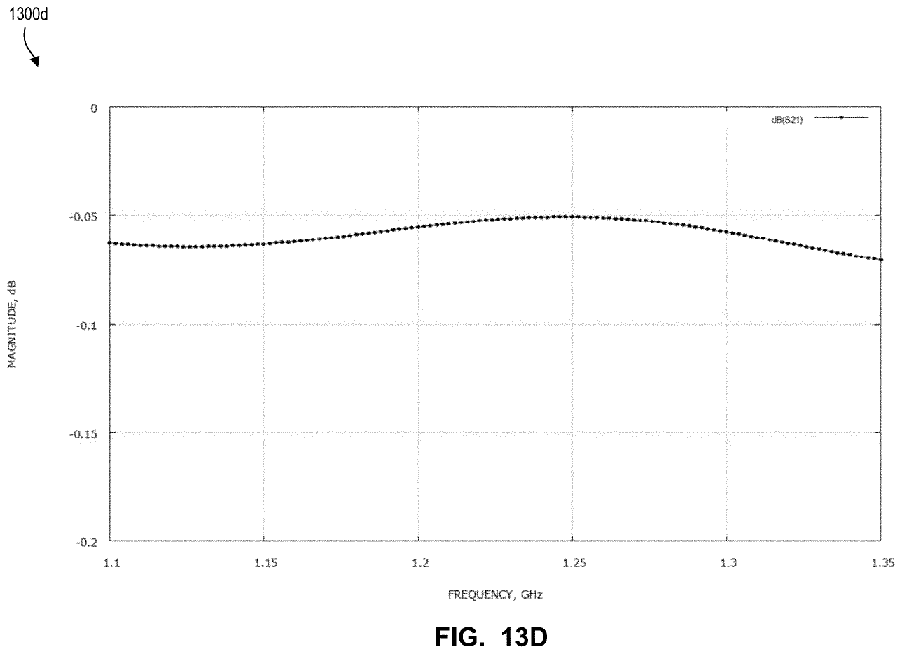

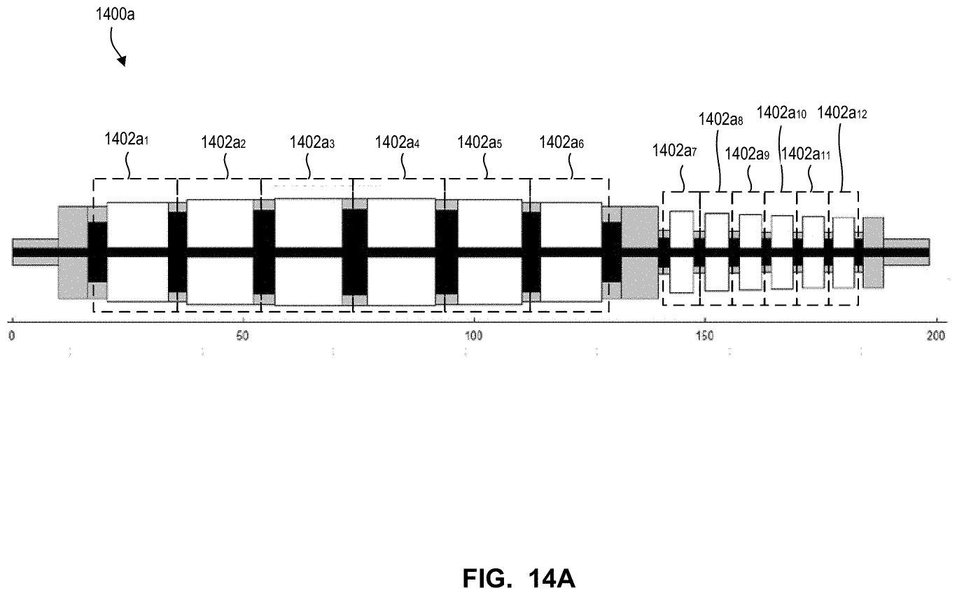

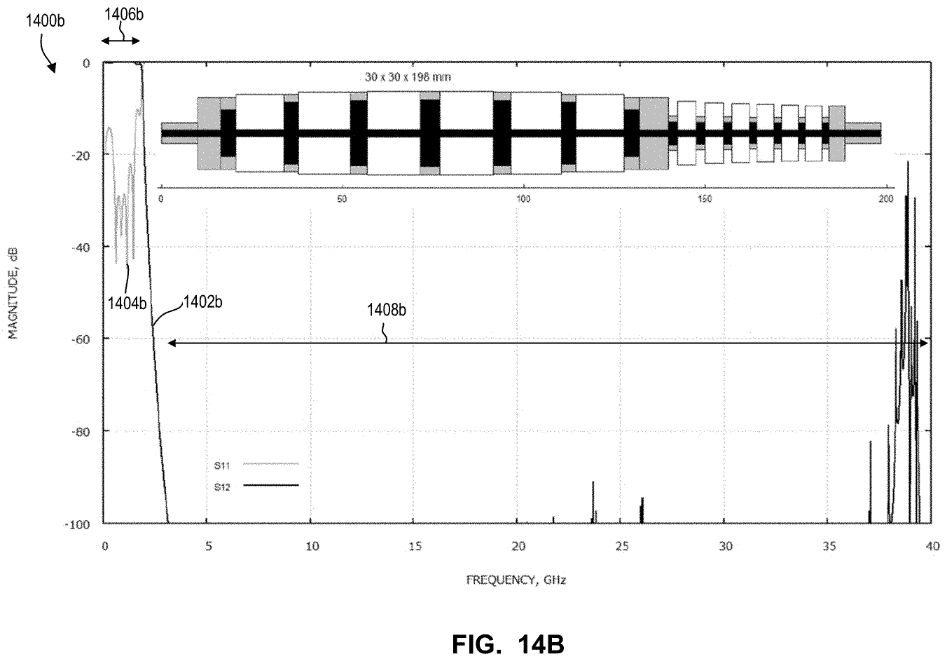

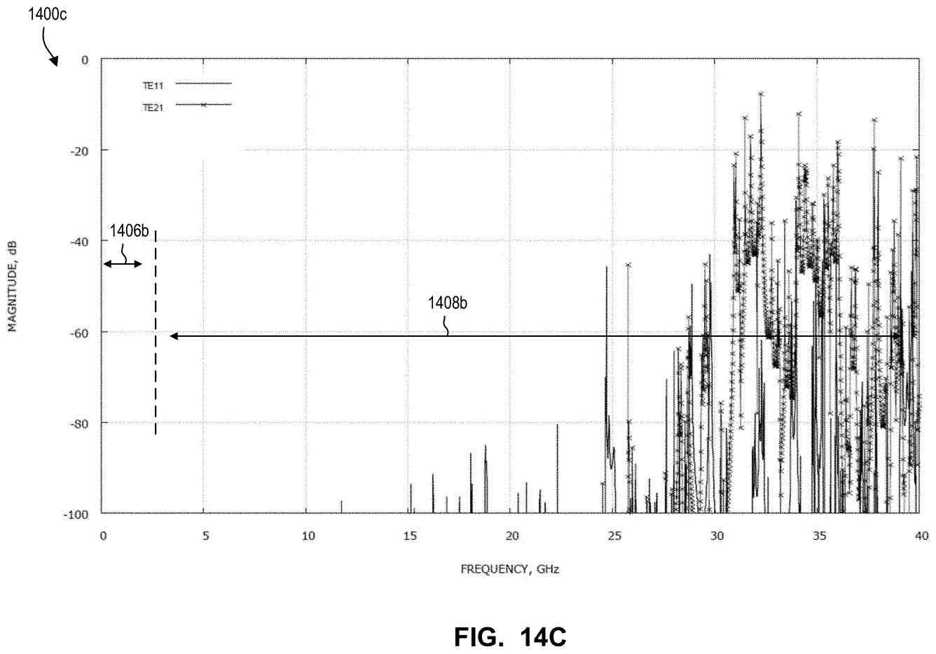

In general, the LPF structure can be configured to have one of a number of exterior designs, including: (a) a constant exterior (FIGS. 9-10); (b) tapered exterior (FIGS. 11-12); (c) stepped-profile (FIG. 13); or a (d) stepped and tapered profile (FIG. 14). It has been appreciated that each of these exterior profiles may offer different potential design benefits with regards to the scattering properties of the cavity junctions (i.e., scattering of transmission zeroes), as well offering various quality metric differences for the LPF structure.

(a) Constant Exterior Coaxial LPF Structure

Referring to FIGS. 9A and 10A, which schematically illustrate example cross-sectional views of LPF structures having a constant exterior. The constant exterior structure results from the constituent cavity junctions having a uniform external radius, with the exception of the input and output interface connections (904a, 906a in FIG. 9A and 1004a, 1006a in FIG. 10A). The constant exterior LPF structure can be realized to achieve both a low-cut off LPF design (FIGS. 9A-9E) or a high cut-off design (FIGS. 10A-10D). In various cases, the constant exterior structure may provide a technologically simple, and cost-effective design for constructing the LPF.

Referring first concurrently to FIGS. 9A-9D. FIG. 9A schematically illustrates an example cross-sectional view of an example LPF structure 900a having a constant exterior, and configured to achieves a low cut-off response.

In particular, as shown in FIG. 9A, the LPF 900a is a quasi-periodic structure having a cascade of cavity junctions 902a-902h (e.g., type “A” cavity junctions) having constant external radius, but varying cavity junction lengths. Each of the cavity junctions 902 is configured to generate cavity-specific transmission zeroes at target frequencies.

In the illustrated embodiment, the LPF structure 900a has a diameter dimension of 30 mm, and a length dimension of 168 mm, and is designed to ideally generate a stop band of approximately 2.0 GHz to 32 GHz.

FIG. 9B shows an example simulated frequency plot 900b, generated by the LPF structure 900a, for the dominant (TEM) mode, and shows the transmission properties 902b versus the reflection properties 904b.

As shown by the plotted transmission properties 902b in FIG. 9B, the LPF structure 900a generates an effective pass band zone 906b, an effective stopband zone 908b and a spurious zone 910b. In particular, the LPF structure 900a generates an LPF response having a low frequency cut-off (e.g., approximately 3 GHz), with the effective stopband zone 908b being generated from the scattering of multiple transmission zeroes—generated by each of the cavity junctions 902.

As compared to the frequency plot response 400 of FIG. 4A using the conventional LPF structure 300 (FIGS. 3A and 3B), the effective stop-band in FIG. 9B is significantly wider for the dominant TEM mode, and demonstrates continuous attenuation (e.g., approximately 3 to 10 GHz in FIG. 9A, versus 3 GHz to 7 GHz in FIG. 4A).

FIG. 9C shows an example simulated frequency plot 900c, generated by the LPF structure 900a, for each of the low-order TE spurious modes (i.e., TE₁₁, TE₂₁ and TE₃₁). As shown, the LPF structure 900a also demonstrates generally constant attenuation of the low-order TE spurious modes over the stopband 908b, which is comparable to the attenuation of the low-order TE modes in the conventional structure of FIG. 3.

FIG. 9D shows an example frequency plot 900d of the insertion loss over the targeted passband. As shown, the insertion loss of the novel coaxial LPF structure 900a is comparable to the conventional LPF filter 300 of FIG. 3.

FIG. 9E shows another embodiment of the constant exterior coaxial LPF structure 900e. This structure 900e is similar to the LPF structure 900a of FIG. 9A but is based on a more technologically simplified and cost-effective construction based on a tube for external ground surface, a tubular dielectric insert 902e and an internal conductor structure 904e.

In view of the foregoing, despite the external visual similarity between the novel LPF structure 900a and the conventional LPF filter 300 of FIG. 3—i.e., both having a constant exterior envelope—the LPF 900a demonstrates improved reflection and transmission properties, as well as in-band and near-band response functions. More specifically, the novel coaxial filter design is able to provide a wider continuous, high stopband quality as compared to the conventional filter design. In particular, this is owing to the use of controlled transmission zeroes generated by using coupled resonances of spurious modes, which are not otherwise used in conventional structures. Further, as compared to the conventional filter, the novel LPF structure tends toward shorter cavities with greater external radii (e.g., thicker diameter), which—as explained herein—provides favorable conditions for generating transmission zeroes. Additionally, the novel filter design does not present poorer attenuation properties for spurious TE modes (TE₁₁, TE₂₁), or poorer insertion loss properties, than the conventional design.

Referring now to FIGS. 10A-10C. FIG. 10A schematically illustrates an example cross-sectional view of an example LPF structure 1000a having a constant exterior envelope, and is configured to achieve a high cut-off response. As shown, the LPF structure 1000a is formed of cascaded type “B” cavity junctions 1002a₁-1002a₈. In the example embodiment, the LPF structure 1000a has dimensions of 22 mm (width)×22 mm (height)×81 mm (length), and is constructed to generate a stopband width of between 8 GHz to 32 GHz.

FIG. 10B shows a simulated frequency plot 1000b for the dominant TEM mode response for the example LPF structure 1000a of FIG. 10A, and showing the transmission response 1002b versus the reflection response 1004b, as well as each of the effective passband 1006b, stopband 1010b, and spurious TEM resonant responses 1010c.

As shown, the LPF structure 1000a demonstrates a high-quality (e.g., strong attenuation) stopband for the dominant TEM mode within the frequency range of 8 GHz to approximately 26 GHz. Some spurious TEM responses (e.g., TEM₁) are located in a spurious zone 1010c.

FIG. 10C shows a simulated frequency plot 1000c for low-order TE modes response (TE₁₁ and TE₂₁) for the example LPF structure 1000a of FIG. 10A. As shown, while some spurious low-order TE frequencies are located within the stopband (i.e., 1002c), the spurious responses are heavily attenuated.

Accordingly, it can be observed that the high-cut off LPF constant exterior coaxial filter design provides strong, continuous attenuation characteristics over at least part of the desired wide stopband. Analogous conventional LPF filter designs, which demonstrate equal high quality stopband and effective performance, are not common.

Despite several appreciated advantages offered by a constant exterior design (e.g., cost-effective design), the scattering range for this design can be relatively narrow, as the physical parameters of the cavity are limited to keeping a constant external radii.

(b) Tapered Exterior Coaxial LPF Structure

To increase the range of transmission zeroes generated by the cascaded LPF coaxial structure, the exterior of the LPF can be tapered (or variable) as a result of gradually varying the profile of the external and internal cavity junctions along the filter channel. In other words, resulting from varying the external radii of the LPF, the tapering may allow distribution of transmission zeroes over a wider bandwidth to achieve broadband stopband having a greater and continuous attenuation.

As provided in further detail herein, the tapered structure can also achieve enhanced performance of attenuation of propagating spurious waveguide modes (e.g., modes higher than the dominant TEM mode). In particular, this results from the larger flexibility and degrees of freedom in varying important cavity dimensions (e.g., internal and external radii of the cavities). This, in turn can allow the tapered exterior LPF structure to achieve improved electrical performance. Still further, the in-band and near-band performance of the tapered design is also enhanced resulting from the ability to provide larger cavities with less loss factors to form the pass-band, roll-off and near-band attenuation. In various cases, the tapered structure can be achieved using production methods which include milling, EDM and 3D printing. The coaxial tapered LPF structure can be realized to achieve both a low-cut off LPF design (FIGS. 11A-11C) or a high cut-off design (FIGS. 12A-12C).

Referring now to FIG. 11A, which schematically illustrates a cross-sectional view of an example low cut-off LPF structure 1100a having a tapered exterior structure. The low cut-off LPF structure 1100a can be formed from cascading one or more type “A” cavity junctions, which are adapted for generating transmission zeroes at lower frequencies ranges.

As shown, the cascaded cavity junctions 1102a₁-1102a₁₁ are chained in a quasi-periodic tapered structure. In particular, it can be observed that the external and internal radii of the cavity junction is gradually altered over the length of the LPF structure.

In the exemplified embodiment, the LPF structure 1100a has dimensions of 24 mm (maximum height)×12 mm (width)×98 mm (length). The LPF structure 1100a is designed for a stopband from approximately 2 GHz to 32 GHz.

FIG. 11B illustrates a frequency response plot 1100b for the dominant TEM mode for the LPF structure 1100a, showing the transmission response 1102b versus the reflection response 1104b, as well as the effective passband 1106b and the stopband 1108b. As shown, the stopband quality is high and continuously extends from the roll-off (e.g., 3 GHz) to 11 GHz, with high attenuation of higher-order TEM spurious resonant modes.

FIG. 11C illustrates a frequency response plot 1100c for low-order spurious TE modes (TE₁₁ and TE₂₁), for the LPF structure 1100a. As shown, in the effective stop band 1108b, the spurious modes are heavily attenuated in contrast to conventional design structures.

Referring now to FIG. 12A, which schematically illustrates a cross-sectional view of an example high cut-off LPF structure 1200a having a tapered exterior structure. The high cut-off LPF structure 1200a can be formed from cascading one or more type “B” cavity junctions, which are adapted for generating transmission zeroes in higher frequencies ranges. In the exemplified embodiment, the LPF structure 1200a has dimensions of 24 mm (maximum height)×12 mm (width)×98 mm (length), and is designed for a stopband from approximately 8 GHz to 32 GHz.

FIG. 12B illustrates a frequency response plot 1200b for the dominant TEM mode, for the LPF structure 1200a. The frequency plot 1200b shows the transmission response 1202b versus the reflection response 1204b, as well as the passband 1206b and the stopband 1208b. As shown, the stopband quality is high and continuously extends from the roll-off (e.g., 8 GHz) to 32 GHz, with high attenuation of higher-order TEM spurious modes. In particular, the LPF coaxial filter performs broadband and continuous attenuation of frequencies from the roll-off to about the 30th harmonic. Therefore, the design demonstrates a better trade-off between pass-band and stop-band qualities than conventional coaxial filters.

FIG. 12C illustrates a frequency response plot 1200c for low-order spurious TE modes (TE₁₁ and TE₂₁), for the LPF structure 1200a., and showing modest attenuation of spurious TE modes.

Accordingly, in view of the foregoing, the tapered coaxial LPF structure provides enhanced, wide stopbands, with a greater range for scattering transmission zeroes.

(c) Stepped Profile Composite Coaxial LPF Structure

A stepped profile LPF structure may also provide some appreciated advantages from a technological point of view as a result of the profile being realizable using a simpler mechanical structure, and further, being describable with few numbers of dimensions and requiring fewer machining operations and simpler programming. Additionally, from an electrical perspective, a stepped external profile may achieves enhanced spurious suppression.

Referring now to FIG. 13A, which schematically illustrates a cross-sectional view of an example LPF structure 1300a having a stepped profile exterior structure based on a combined low cut-off portion (i.e., type “A” cavity junctions 1302a₁-1302a7) and high cut-off portion (i.e., type “B” cavity junctions 1302a₈-1302a₁₅) with constant external diameters. The exemplified LPF structure 1300a has dimensions of 30 mm (height)×30 mm (width)×208 mm (length), and is designed to generate a stopband from 2 GHz to 32 GHz.

In particular, it has also been appreciated that if each of the cascaded chain of cavities is designed based on keeping the effective characteristic impedance corresponding to the period junction to be about equal to the interface impedance (e.g., 50 ohm), then the portion can be cut at any period and still be matched with an input/output interface. Accordingly, these portions could be easier connected to each other with flexible number of periods.

FIG. 13B illustrates a frequency response plot 1300b for the dominant TEM mode, for the LPF structure 1300a. The frequency plot 1300b shows the transmission response 1302b versus the reflection response 1304b, as well as the passband 1306b and the stopband 1308b. As shown, the stopband quality is high and continuously extends from the roll-off (e.g., 3 GHz) to 32 GHz, with high attenuation, while showing good return.

FIG. 13C illustrates a frequency response plot 1300c for low-order spurious TE modes (TE₁₁ and TE₂₁), for the LPF structure 1300a, and showing the TE spurious response being heavily attenuated in the stopband 1308. FIG. 13D shows a plot 1300d of the insertion loss over the stopband, and demonstrating high quality performance.

(d) Stepped and Tapered Profile Composite Coaxial LPF Structure

A similar design approach can also be used to compose a coaxial low-pass filter from tapered portions. In particular, the tapered profiling achieves an overall improved electrical performance than the stepped profile, while keeping the same exterior dimensions.

Referring now to FIG. 14A, which schematically illustrates a cross-sectional view of an example LPF structure 1400a having a stepped and tapered profile exterior based an TNC coaxial low-pass filter. In particular, the structure 1400a includes two partial filters performing the low cut-off (i.e., type “A” cavity junctions 1402a₁-1402a₆) and high cut-off functions (i.e., type “B” cavity junctions 1402a₇-1402a₁₂). The LPF structure 1400a has dimensions of 30 mm (height)×30 mm (width)×198 mm (length), and is designed for a stopband from approximately 2 GHz to 32 GHz. Both partial filters are based on quasi-periodic structures of 50-ohm characteristic impedance. In particular, both the high and low cut-off portions are directly connected and matched to each other and to the interface.

FIG. 14B illustrates a frequency response plot 1400b for the dominant TEM mode, for the LPF structure 1400a. The frequency plot 1400b shows the transmission response 1402b versus the reflection response 1404b, as well as the passband 1406b and the stopband 1408b. As shown, the stopband quality is high and continuously extends from the roll-off (e.g., 3 GHz) to 38 GHz, with high attenuation.

FIG. 14C illustrates a frequency response plot 1400c for low-order spurious TE modes (TE₁₁ and TE₂₁), for the LPF structure 1400a. FIG. 14D shows a plot 1400d of the insertion loss over the stopband, and demonstrating high quality performance.

(e) High Band Application LPF Structure

In addition to low frequency application, the coaxial LPF structure can also be deployed for various high frequency applications (e.g., miniature microwave applications and in higher frequency bands (C, X, Ku and K bands)). High frequency applications typically present more challenges for coaxial applications due to overmoding, size reduction, loss increase and power handling reduction. Nevertheless, the disclosed high cut-off coaxial LPF design, based on quasi-periodic chain of type “B” cavity junctions, can effectively fit high band applications as the coaxial structure performs selectivity while utilizing relatively big cavities and gaps.

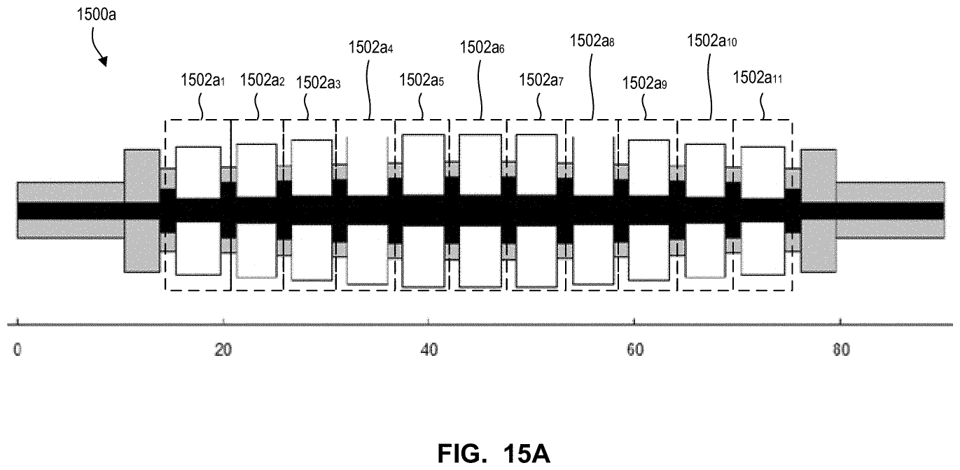

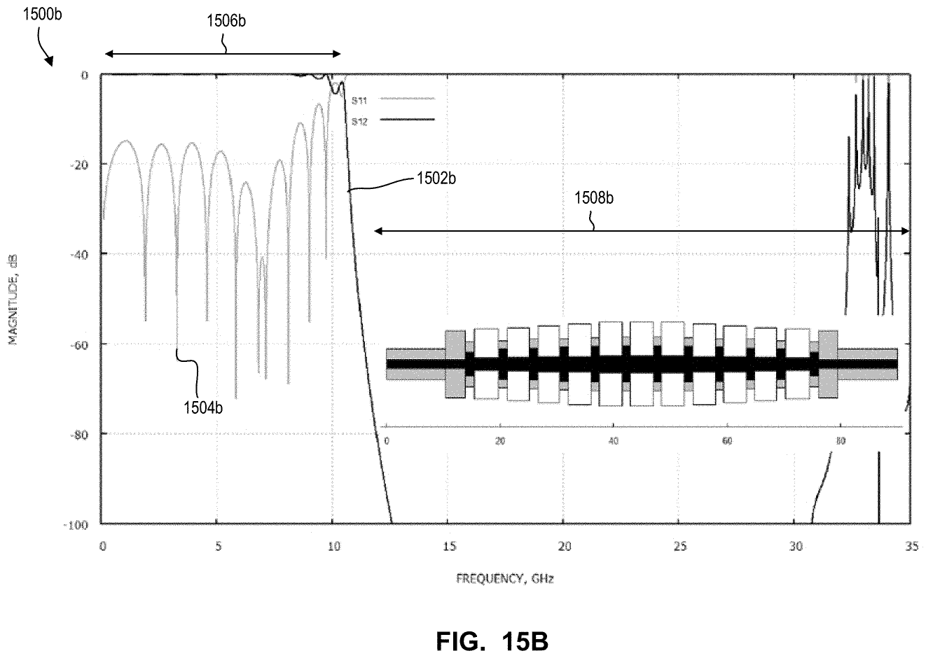

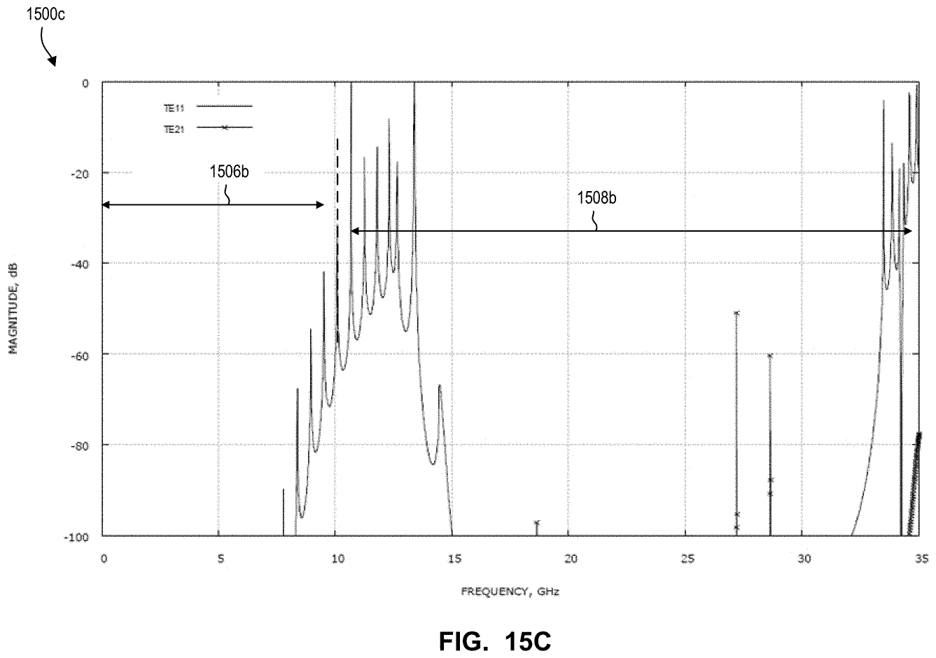

Referring now to FIG. 15A, which schematically illustrates a cross-sectional view of an example LPF structure 1500a for a TNC coaxial LPF which has been designed based high cut-off type “B” cavity junctions (i.e., cavity junctions 1502a₁-1502a₁₁) designed for X-band frequencies.

FIG. 15B illustrates a frequency response plot 1500b for the dominant TEM mode, for the LPF structure 1500a. The frequency plot 1500b shows the transmission response 1502b versus the reflection response 1504b, as well as the effective passband 1506b and the stopband 1508b. As shown, the design shows a good match at 7.0-7.5 GHz and a clean spurious-free stop-band from about 14 GHz to 32 GHz. FIG. 15C illustrates a frequency response plot 1500c for low-order spurious TE modes (TE₁₁ and TE₂₁), for the LPF structure 1500a.

3. Mathematical Modelling Approximation of Cavity Junctions Generating Transmission Zeroes

The following provides a mathematical modelling approximation for electromagnetic scattering occurring inside of cavity junctions (e.g., cavity junction 500a in FIG. 5A) to provide a better understanding of the basis for configuring cavity junctions as either type “A” or type “B” cavity junctions.

As provided, the cavity junctions (e.g., cavity junction 500) are represented herein as a single discontinuity in a coaxial waveguide, and are represented as a uniaxial connection of three coaxial lines (e.g., small-large-small) (i.e., a “three waveguide” representation). Based on this representation, equations are derived (e.g., Equation (1), below) which account for all internal modal interactions. This is in contrast to the common approach, which is based on a representation of discontinuities as “step-junctions” (e.g., a uniaxial connection of two coaxial lines with different impedances (or cross sections)). In particular, this common approach represents each discontinuity as an equivalent circuit of two ideal transmission lines of different impedances connected to each other with a shunt capacitance. When such step-junctions are connected as irises or cavities, only the dominant TEM mode is accounted for. Therefore, these representations fail to show the development of transmission zeros, and in turn, fail to allow for designing cavity junctions based on controlled generation of transmission zeroes. In particular, as provided in further detail herein,

In particular, Equation (1) represents a multi-modal admittance matrix used to mathematically model the electromagnetic scattering inside of a cavity junction. In particular, Equation (1) is based on a rigorous solution for Maxwell equations considering all possible scattering effects (see F. De Paolis, R. Goulouev, J. Zheng, M. Yu [1]).

$$\{ \begin{matrix}{Y}_{ks}^{11} = {Σ}_{n} {y}_{n} \frac{{α}_{kn}^{( 1 )} {α}_{sn}^{( 1 )}}{j tan ( {β}_{n} L )} & {Y}_{ks}^{12} = - {Σ}_{n} {y}_{n} \frac{{α}_{kn}^{( 1 )} {α}_{sn}^{( 2 )}}{j tan ( {β}_{n} L )} \\ {Y}_{ks}^{21} = - {Σ}_{n} {y}_{n} \frac{{α}_{kn}^{( 2 )} {α}_{sn}^{( 1 )}}{j tan ( {β}_{n} L )} & {Y}_{ks}^{22} = {Σ}_{n} {y}_{n} \frac{{α}_{kn}^{( 2 )} {α}_{sn}^{( 2 )}}{j tan ( {β}_{n} L )}\end{matrix} \qquad ( 1 )$$

wherein n is a propagation mode number, L is a length of the cavity (i.e., length 508 in FIG. 5B), yₙ is a wave admittance for the n^{th} mode, βₙ is a propagation constant for the n^{th} mode, and the α-values are aperture integrals on the input and output nodes (i.e., 506a, 506b in FIG. 5B) of the cavity junction. Further, k, s, and n are generalized modal indexes, wherein k and s are for the incident modes, and n is for the internal cavity modes. In particular, Equation (1) is derived for a general junction (e.g., rectangular waveguide, circular, ridged waveguides or coaxial line, etc. or mixed). As indexation of modes of any type of waveguide is different, in generalized indexation, the modes are counted sorted by their cut-off numbers in ascending order. For example, in Equation (1), k and s, are associated with Y-matrix rows and columns while n-numbers are running in sum from 0 to infinity. In the provided approximation, k=s=0 (e.g., TEM mode), and n runs from 0 (TEM) to infinity (TM₀ₙ).

The aperture integrals in Equation (1) are determined according to Equations (2a)-(2d) (also collectively referred to as Equation (2)) (see F. De Paolis, R. Goulouev, J. Zheng, M. Yu [1]).

$$\begin{matrix}{α}_{kn}^{( 1 )} = \int {\int }_{g 1} {\underline{E}}_{k}^{( 1 )} \cdot {\underline{E}}_{n} dxdy & ( 2 a ) \\ {α}_{sn}^{( 1 )} = {\int \int }_{g 1} {\underline{E}}_{s}^{( 1 )} \cdot {\underline{E}}_{n} dxdy & ( 2 b ) \\ {α}_{kn}^{( 2 )} = {\int \int }_{g 2} {\underline{E}}_{k}^{( 2 )} \cdot {\underline{E}}_{n} dxdy & ( 2 c ) \\ {α}_{2 n}^{( 2 )} = {\int \int }_{g 2} {\underline{E}}_{s}^{( 2 )} \cdot {\underline{E}}_{n} dxdy & ( 2 d )\end{matrix}$$

wherein g1 and g2 are the two accessible nodes of the cavity junction (e.g., 506a, 506b in FIG. 5B), Eₖ⁽¹⁾ and Eₖ⁽²⁾ are transverse electric fields—for the first and second accessible nodes respectively—for the k^{th} mode, and Eₛ⁽¹⁾ and Eₛ⁽²⁾ are the transverse electrical fields—for the first and second accessible nodes, respectively—for the s^{th} mode, and Eₙ is the transverse electric field in the n^{th} mode inside the cavity portion 504.

In order to model cavity junctions as provided herein, a simulation tool is used based on mode-matching computational method. In particular, each junction cavity junction is solved in terms of Equation (1) with an adequate number of modes.

In the case the cavity junction is assumed to be a concentric junction, all values of coupling integrals in Equation (2)—corresponding to the waveguide modes of different azimuthal index (e.g., n-index in TEₙₘ/TMₙₘ modes, and n=0 for TEM modes) become zero, as on such discontinuity, each waveguide mode can only excite another waveguide mode of the same azimuthal symmetry. Accordingly, this results in the admittance matrix of Equation (1) being a diagonal block matrix having diagonal elements corresponding to a Y-matrix corresponding to a family of waveguide modes having certain index “n”, and with all sums in Equation (1) being one dimensional.

However, as to further simplify the admittance matrix in Equation (1)—which can become complex if expressed in terms of elementary functions—a simplified 2×2 normalized Y-matrix approximation can be used, which corresponds to the dominant mode (TEM-mode) of scattering (see e.g., N. Marcuvitz [2]).

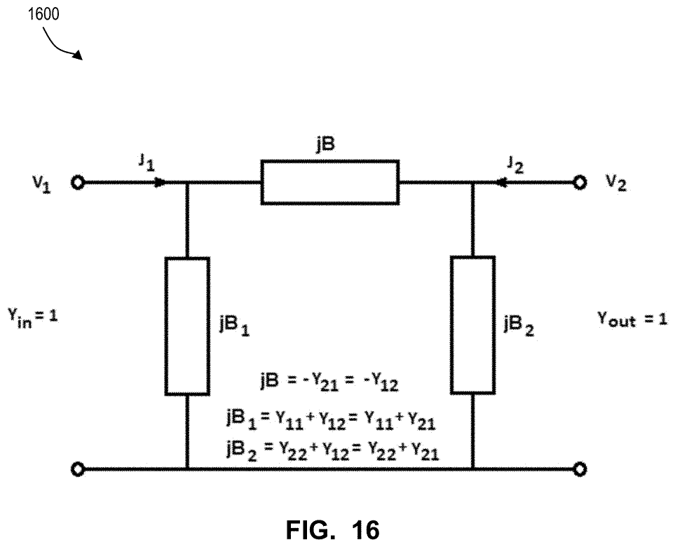

Referring now briefly to FIG. 16, there is shown an equivalent π-network 1600 modelling of the cavity junction which can be used to derive a relatively simple expression for the Y-matrix members (see e.g., N. Marcuvitz [2]). In particular, the equivalent network in FIG. 16 can be used to derive a normalized matrix

$$[ \begin{matrix}{y}_{11} & {y}_{12} \\ {y}_{21} & {y}_{22}\end{matrix} ]$$

with matrix elements in accordance with Equations (3a)-(3c) (also collectively referred to herein as Equation (3)).

$$\begin{matrix}{y}_{11} = - j \sqrt{\frac{{ɛ}_{r}}{{μ}_{r}}} \cdot \sqrt[4]{\frac{{μ}_{r 1} {μ}_{r 2}}{{ɛ}_{r 1} {ɛ}_{r 2}}} ( \frac{{( {α}_{0}^{( 1 )} )}^{2}}{tan ( k \cdot L )} - {\sum }_{m = 1}^{∞} \frac{k}{\sqrt{{X}_{m}^{2} - {k}^{2}}} \cdot \frac{{( {α}_{m}^{( 1 )} )}^{2}}{tanh ( \sqrt{{X}_{m}^{2} - {k}^{2} - L} )} ) & ( 3 a ) \\ {y}_{12} = {y}_{21} = j \sqrt{\frac{{ɛ}_{r}}{{μ}_{r}}} \cdot \sqrt[4]{\frac{{μ}_{r 1} {μ}_{r 2}}{{ɛ}_{r 1} {ɛ}_{r 2}}} ( \frac{{α}_{0}^{( 1 )} \cdot {α}_{0}^{( 2 )}}{sin ( k \cdot L )} - {\sum }_{m = 1}^{∞} \frac{k}{\sqrt{{X}_{m}^{2} - {k}^{2}}} \cdot \frac{{α}_{m}^{( 1 )} \cdot {α}_{m}^{( 2 )}}{sinh ( \sqrt{{X}_{m}^{2} - {k}^{2} - L} )} ) & ( 3 b ) \\ {y}_{22} = - j \sqrt{\frac{{ɛ}_{r}}{{μ}_{r}}} \cdot \sqrt[4]{\frac{{μ}_{r 1} {μ}_{r 2}}{{ɛ}_{r 1} {ɛ}_{r 2}}} ( \frac{{( {α}_{0}^{( 2 )} )}^{2}}{tan ( k \cdot L )} - {\sum }_{m = 1}^{∞} \frac{k}{\sqrt{{X}_{m}^{2} - {k}^{2}}} \cdot \frac{{( {α}_{m}^{( 2 )} )}^{2}}{tanh ( \sqrt{{X}_{m}^{2} - {k}^{2} - L} )} ) & ( 3 c )\end{matrix}$$

Table 2, below, provides a summary of the various parameters and variables used in Equation (3).

TABLE 2
Parameters and Variables in Equation (3)

| Parameter/ | |
|---|---|
| Variable | Definition |
| εᵣ, μᵣ | Relative permittivity and permeability of cavity filling |
| εᵣ₁, μᵣ₁ | Relative permittivity and permeability of input node |
| εᵣ₂, μᵣ₂ | Relative permittivity and permeability of output node |
| k | Wave number in vacuum k = \sqrt{εᵣμᵣ} · k0 and |
| | $associated with frequency f = \frac{c \cdot k}{2 π \sqrt{{ϵ}_{r} {μ}_{r}}}$ |
| k₀ | Wave number in vacuum, wherein k₀ = 2πƒ/c, |
| | and is associated with frequency ƒ = c · k₀/2π |
| c | Light speed in vacuum |
| Xₘ | m-th eigen number corresponding to |
| | TM₀ₘ -mode in the cavity waveguide, |
| | which is m-th root of equation J₀(χ · R₀) · |
| | Y₀(χ · R₁) − Y₀(χ · R₀) · J₀(χ · R₁) = 0 |
| αₙ^{(1,2)} | Integrals in Equations (2) − (5) corresponding |
| | to the TEM mode to TEM (n = 0), or |
| | TM_{0,n} (n ≠ 0) coupling for input and output apertures |
| L | Length of cavity |

The first term enclosed in the brackets in each of Equations (3a) and (3b) are associated with the dominant TEM-mode scattering, while each term in each of the sums is associated with the coupling between the incident dominant mode and a corresponding TM_{0,m}-mode

Equation (3) allows for derivation of Equations (4a)-(4c) (collectively referred to herein as Equation (4)) in respect of the s-parameters (i.e., the scattering parameters) based on the equivalent π-network in FIG. 16.

$$\begin{matrix}{s}_{11} = \frac{〈 {y}_{11} - 1 〉 \cdot 〈 {y}_{22} + 1 〉 - {y}_{12}^{2}}{{y}_{12}^{2} - {y}_{11} \cdot {y}_{22} - {y}_{11} - {y}_{22} - 1} & ( 4 a ) \\ {s}_{22} = \frac{〈 {y}_{11} + 1 〉 \cdot 〈 {y}_{22} - 1 〉 - {y}_{12}^{2}}{{y}_{12}^{2} - {y}_{11} \cdot {y}_{22} - {y}_{11} - {y}_{22} - 1} & ( 4 b ) \\ {s}_{12} = {s}_{21} = \frac{- 2 \cdot {y}_{12}}{{y}_{12}^{2} - {y}_{11} \cdot {y}_{22} - {y}_{11} - {y}_{22} - 1} & ( 4 c )\end{matrix}$$

Other types of coaxial waveguide modes (e.g., TE_{n,m}) are not reflected in these equations because they are generally not excited by the dominant TEM mode.

A brief mathematical analysis applied to Equations (3) and (4) shows that the bracketed terms in Equation (3) has an infinite number of ∓∞ singularities over the normalized frequency domain

$$κ ( f = \frac{c}{2 π \sqrt{{ϵ}_{r} {μ}_{r}}} \frac{κ}{L} )$$

corresponding to excitation of waveguide modes. Therefore, there should be an infinite number of frequency points when the non-diagonal y-matrix elements y₁₂ and y₁₂ turn into zero, resulting in disconnection of the middle portion of the π-network (FIG. 16) (i.e., resulting in no transmission through the cavity junction). According to this simplified model, at those frequency points, the dominant TEM-mode will not propagate through the cavity and is completely reflected. Those frequency points, when y₁₂=y₂₁=0, are transmission zeros. Ideally, in vice versa, the π-network would be completely shorted if y₁₁+y₁₂=±∞ or y₂₂+y₁₂=∓∞.

According to a detailed analysis of Equation (3), however, the short circuit conditions when y₁₁+y₁₂=±∞ or y₂₂+y₁₂=±∞ do not happen, because the both terms have the same singularities with opposite signs and therefore remove each other. Accordingly, only the condition (y₁₂=y₂₁=0) defines a transmission zero. According to logic based on continuousness and smoothness of the y-matrix in Equation (3) between the transmission zeros, the infinite reflection zeros or bands of low reflection coefficient (low reflectivity) will also exist over the frequency domain. The analysis also shows that if κ→0, y₁₁+y₁₂→0, y₂₂+y₁₂→0 and y₁₂=y₁₂→∞, which means a trivial reflection zero is located at DC. However, from practical and simplicity reasons, only transmission zeros corresponding to first two “spurious” modes (TM₀₁ and TM₀₂) are considered and utilized here for the design.

(a) Approximation for Type “A” Cavity Junctions

The mathematical model of the cavity junction in Equations (3) and (4) can be used to model type “A” cavity junction behavior, which is operable to generate transmission zeroes caused by a dual-mode coupling when the dominant mode TEM excites TEM₁ and TM₀₁₀ coupled resonances

In particular, Equation (3b) can be approximated in the vicinity of a second mode cut-off (e.g., m=1) in accordance with Equation (5).

$${y}_{12} ( κ , τ ) = {y}_{21} ( κ , τ ) = j \cdot \frac{{ζ}_{0}}{κ} \cdot \frac{1.18 \cdot ( {τ}^{2} - {κ}^{2} ) \cdot ( 1 + \frac{{τ}^{2} - {κ}^{2}}{6} ) - α \cdot {κ}^{2} \cdot ( 1 - {( \frac{κ}{π} )}^{2} )}{( 1 - {( \frac{κ}{π} )}^{2} ) \cdot ( {τ}^{2} - {κ}^{2} ) \cdot ( 1 + \frac{{τ}^{2} - {κ}^{2}}{6} )} \qquad ( 5 )$$

wherein Equations (6a)-(6c) express the variables ζ₀, κ, τ, α in Equation (5).

$$\begin{matrix}{ζ}_{0} = \sqrt{\frac{{ɛ}_{r}}{{μ}_{r}}} \cdot \sqrt[4]{\frac{{μ}_{r 1} {μ}_{r 2}}{{ɛ}_{r 1} {ɛ}_{r 2}}} \cdot {α}_{0}^{( 1 )} \cdot {α}_{0}^{( 2 )} & ( 6 a ) \\ κ = kL & ( 6 b ) \\ τ = {X}_{1} L & ( 6 c ) \\ α = \frac{{α}_{1}^{( 1 )} \cdot {α}_{1}^{( 2 )}}{{α}_{0}^{( 1 )} \cdot {α}_{0}^{( 2 )}} & ( 6 d )\end{matrix}$$

Equation (5) is derived from the Equation (3b) using approximations for the first two terms (TEM-TEM and only TEM-TM₀₁ from the sum) in vicinity of the TM₀₁ cut-off in the cavity. The trigonometric terms are approximated in Taylor series for the first two or three terms.

In particular, the roots of Equation (5) (i.e., y₁₂=y₂₁=0) correspond to the transmission zeroes for the TEM and TM₀₁ modes, and can be solved and expressed in terms of the elementary functions in Equations (7a) and (7b).

κ₁=\sqrt{p−\sqrt{Δ}} (7a)

κ₂=\sqrt{p+\sqrt{Δ}} (7b)

wherein “p” and “Δ” are expressed according to Equations (7c) and (7d).

$$\begin{matrix}p = \frac{〈 α + 1.18 + 0.39333 \cdot {τ}^{2} 〉}{2 \cdot ( \frac{α}{{π}^{2}} + 0.19667 )} & ( 7 c ) \\ Δ = {p}^{2} - q & ( 7 d )\end{matrix}$$

and “q^{”} is expressed according to Equation (7e).

$$q = \frac{〈 1.18 \cdot {τ}^{2} + 0.19667 \cdot {τ}^{4} 〉}{( \frac{α}{{π}^{2}} + 0.19667 )} \qquad ( 7 e )$$

Accordingly, by solving for the roots of Equation (5) based on Equations (7a)-(7e), it can be determined that two transmission zeroes exist when Δ>0 (FIGS. 6A-6C), a dual re-generated transmission zero exists when Δ=0 (FIG. 6D), and no transmission zero exists when Δ<0 (FIG. 6E).

In particular, two transmission zeros are located on either sides of the term \sqrt{p} (e.g., the roots include one less and one greater than the term \sqrt{p}). The middle condition, when the both zeros regenerate into a single transmission zero (Δ=0), can be roughly approximated in accordance with Equation (8).

$${τ}_{cr} = \sqrt{1.932 \cdot ( 1 + \sqrt{1 + \frac{{α}^{2} + 2.36 \cdot α + 1.3924}{0.29749 \cdot α}} )} \qquad ( 8 )$$

In the case of a symmetric cavity (e.g., input and output nodes are identical), two reflection zeros can exist between κ₁ and κ₂, corresponding to roots of the numerators of the expressions for S₁₁ and S₂₂ in Equation (4). If the cavity is not symmetric (i.e., input and output nodes are not identical in structural geometry—internal/external radii 512, 516 in FIG. 5B), a bandwidth of low reflectivity can exist when the reflection does not turn into zero, but it can still be low. Either case would correspond to a spurious effect, when the wave transmits through the cavity with zero or little loss. Those effects are commonly called “spurious resonances”, “spurious responses”, etc.

In view of the foregoing, and according to an analysis of those models, some general conclusions can be made:
(i) Transmission zeros do not exist under conditions approximated as Δ<0 in Equation (7). That condition in Equation (8) corresponds to a cavity having a length greater than τ_{cr}/χ₁ (χᵢ is the eigenvalue corresponding to the second mode with cut-off frequency

$$f = \frac{c \cdot {χ}_{1}}{2 π \sqrt{{ϵ}_{r} {μ}_{r}}} ) . \qquad ( FIG . 6 E )$$

(ii) Two transmission zeros exist if the cavity length is shorter than roughly τ_{cr}/χ₁ (FIGS. 6A-6C).
(iii) In the case two transmission zeroes are generated, the transmission zeros can be spaced far apart and separated by reflection zeros or low reflectivity bands (FIG. 6B) when Δ>0 and is significant in comparison with p². In this case a lower transmission zero κ₁ can be designed and placed at corresponding frequency point

$$f = \frac{c \cdot {κ}_{1}}{2 π \sqrt{{ϵ}_{r} {μ}_{r}} \cdot L}$$

by length or cross-section radii adjustment. The design is flexible and for each preselected cavity length L, an appropriate cavity cross-section dimension can be found. Then, the reflection zeros between κ₁ and κ₂ will be associated with spurious responses.
(iv) In the case two transmission zeroes are generated, the transmission zeros can be spaced closely to each other (FIG. 6C) when Δ>0 and Δ/p²«1 (e.g., 0.1 and less) and results in a complete removal of the reflection zeros (e.g., spurious responses). The design, however, is constrained by the condition and can be applicable to certain ratios of couplings (e.g., α-values in Equation (6)).
(v) Both transmission zeros are re-generated into a single transmission zero and coincide (κ₁=κ₂), when Δ=0. This can happen under the condition of Equation (8), and therefore is also restrained by couplings (e.g., α-values in Equation (6)).
(vi) A reflection zero can exist at DC.

Accordingly, the conditions generated based on the mathematical modelling of the tape A cavity junction demonstrate that adjusting the cavity length can vary the type of transmission zeroes generated. Further, adjusting the radial and length dimensions of the cavity junction can vary the location of the generated transmission zeroes.

(b) Approximation for Type “B” Cavity Junctions

The mathematical model of the cavity junction in Equations (3) and (4) can also be used to model type “B” cavity junction behavior, which is operable to generate transmission zeroes caused by a dual-mode coupling when the dominant mode TEM excites TEM₁ and TM₀₂₀ coupled resonances.

In particular, it has been appreciated that the scattering effects associated with the TM₀₁ mode excitation can be removed if one of, or both of, α₁⁽¹⁾ and α₁⁽²⁾ in Equation (3b) turn to zero. Accordingly, in this case, the summation begins from index m=2. This condition results in the same coupling effect, but based on the dominant TEM-mode with the TM₀₂ mode coupling. Further, Equations (5)-(8) hold, assuming α₁⁽¹⁾ is replaced with α₂⁽¹⁾ and α₁⁽²⁾ is replaced with α₂⁽²⁾, and X₁ is replaced with X₂.

Although the TE₀₁ removal does not change the character of the scattering responses, it can be extended further to the TE₀₂-mode cut-off frequency.

FIGS. 7A-7D show an example of simulation of the frequency response of a type “B” cavity junction (e.g., FIG. 5D).

The geometry of the connection between the input and output nodes in the type “B” cavity junctions can be accurately found numerically if using a computer algorithm to find the root of the equation α₁^{(1,2)}. Further, it can be visually noticed that the radial latitude of the median radius of the junction aperture is located slightly lower than the median radius of the cavity cross-section in the type “B” cavity junctions (e.g., FIG. 5D). In the mathematical terms it can be expressed according to Equation (9).

(rᵢₙ+rₑₓ)/2<(Rᵢₙ+Rₑₓ)/2 (9)

wherein Rᵢₙ, Rₑₓ are the internal and external radii of the cavity and rᵢₙ, rₑₓ are internal and external radii of the adjacent smaller coaxial line.

4. Mathematical Modelling of Transmission Properties of Periodic Chain of Cavities

The following provides a mathematical modelling to demonstrate transmission propagation caused by cascading multiple type “A” and type “B” cavity junctions in periodic chains.

In general, periodic chains of cavity junctions provide discrete passbands separated by stopbands, corresponding to each cavity junction (i.e., frequency bands for which a wave propagates freely along the structure separated by frequency bands for which the wave is highly attenuated and does not propagate along the structure).

FIGS. 8A and 8B illustrate an example periodic structure 800 formed from type “B” cavity junctions. For simplicity the periodic structure is shown having symmetric junctions (e.g., same node geometry on both sides).

In order to consider propagation through the periodic chain of cavities, it has been appreciated that periodic structures, which are composed from identical scattering discontinuities, can be considered as a transmission line with a characteristic impedance and propagational constant.

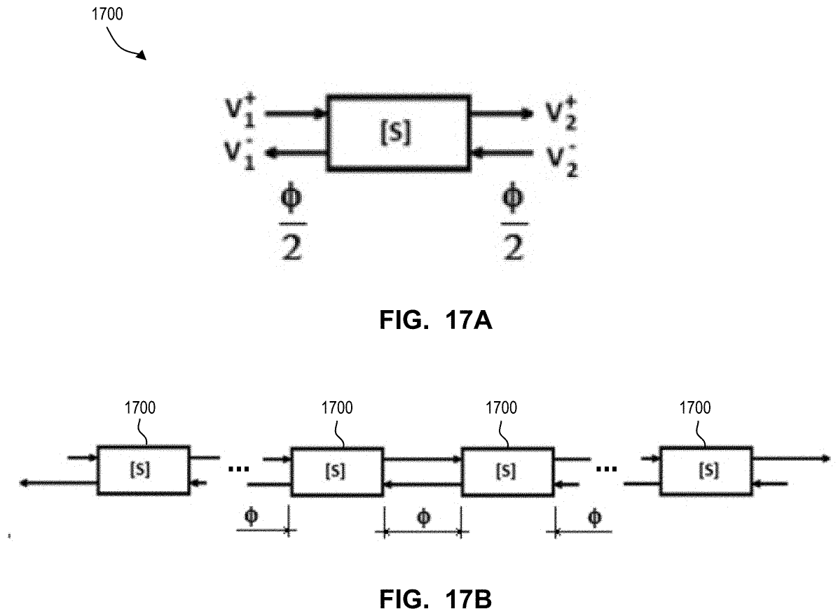

Referring now to FIGS. 17A and 17B, which show a characteristic impedance representation of the periodic structure 800. In particular, as shown in FIG. 17A, each cavity junction 1700 is represented an s-parameter element. As shown in FIG. 17B, the periodic structure 800 is represented as a chain of s-parameter elements connected to each other to form of a transmission line of length (d).

The impedance for a single cavity, in the periodic structure, can be expressed having regard to Equation (10)-(12) (see e.g., R. E. Collin [3] and S. Ramo, J. R. Whinnery, T. V. Duzler [4]).

First, the reflected waves from the s-matrix in Equation (4) and the incident waves can be expressed according to Equation (10).

$$[ \begin{matrix}{V}_{1}^{-} \\ {V}_{2}^{+}\end{matrix} ] = exp ( - j φ ) \cdot [ \begin{matrix}{S}_{11} & {S}_{12} \\ {S}_{21} & {S}_{22}\end{matrix} ] [ \begin{matrix}{V}_{1}^{+} \\ {V}_{2}^{-}\end{matrix} ] \qquad ( 10 )$$

wherein V₁⁻, V₁⁺ are the voltages at a first node of the cavity junction, V₂⁺, V₂⁻ are voltages at a second node of the cavity junction, Sₙₘ are elements of the scattering matrix, and φ is expressed according to Equation (11).

φ=\sqrt{εᵣ₀μᵣ₀}·k₀·d (11)

wherein εᵣ₀, μᵣ₀ and k₀ are defined according to Table 1, and d is the length of the cavity junction.

The propagation condition is further expressed according to Equations (12a) and (12b).

V₂⁺=V₁⁺·exp(−jθ) (12a)

V₂⁻=V₁⁻·exp(−jθ) (12b)

The s-parameters in Equation (10) can be expressed using the normalized Y-matrix terms in Equations (4a)-(4c), and further, the propagation conditions in Equations (12a)-(12b) can be substituted into Equation (10). Assuming a symmetric cavity (e.g., y₁₁=y₂₂), the obtained uniform linear system of equations can be solved to obtain Equation (13).

$$cos ( θ ) = \frac{j \cdot ( {y}_{12}^{2} - {y}_{11}^{2} - 1 ) \cdot sin ( φ ) - 2 {y}_{11} \cdot cos ( φ )}{2 {y}_{12}} \qquad ( 13 )$$

According to Equation (13), propagation is possible through the cavity junction when the value expression is in a range of (−1, 1), otherwise the value becomes a complex value, which corresponds to attenuation of transmission.

In particular, propagation occurs when the right part of the expression in Equation (13) does not exceed unity in absolute value and the solution of the equation is a real number. However, if the propagation frequency increases, then the right side of Equation (13) also increases until it becomes more than unity in absolute value, which results in evanescent propagation with an imaginary solution of Equation (13) corresponding to a stop-band, which occurs at the cavity transmission zero frequencies. If the frequency is further increased from the last transmission zero, the right side of Equation (13) reduces by its imaginary value until it turns into a real value, when the propagation occurs with no attenuation. Those frequency bands correspond to the excitation of the other resonances of the order higher than the utilized resonances (TEM₁/TM₀₁₀ or TEM₁/TM₀₂₀ respectively).

The transmission through “N” cavities can be determined according to Equation (14).

T_{N}=exp(−j·N·φ) (14)

Equation (15) expresses the relative characteristic impedance (e.g., impedance normalized to the characteristic impedance of the interface nodes) of a cavity junction in the periodic structure.

$${z}_{c} = \frac{{V}_{1}^{+} + {V}_{1}^{-}}{{V}_{1}^{+} - {V}_{1}^{-}} \qquad ( 15 )$$

Equation (16) shows Equation (15) expressed in-terms of the y-matrix terms in Equations (3a)-(3c).

$${z}_{c} = \frac{j \cdot ( {y}_{11} sin ( φ ) - {y}_{12} sin ( θ ) ) + 1 - ( {y}_{11}^{2} - {y}_{12}^{2} + 1 ) {( sin θ / 2 )}^{2}}{j \cdot ( {y}_{11} sin ( φ ) - {y}_{12} sin ( θ ) ) - 1 + ( {y}_{11}^{2} - {y}_{12}^{2} + 1 ) {cos ( φ / 2 )}^{2}} \qquad ( 16 )$$

The absolute value of the characteristic impedance can then be expressed in accordance with Equation (17).

Z_{c}=Z_{c0}·z_{c} (17)

wherein Z_{c0} is the absolute impedance (e.g., expressed voltage over current ratio) of the interface coaxial lines connected to the cavity from both sides.

Based on Equations (13)-(17), it has been appreciated that propagation takes place at low frequencies when θ approaches φ, and z_{c} approaches unity. Further, when the frequency is increasing, y₁₂ is reducing by magnitude and, at certain conditions, the absolute value of Equation (13) becomes greater than unity, resulting in attenuation.

It is also appreciated that the right side of Equation (13) becomes singular and infinite when y₁₂=0 (i.e., the previously defined condition for generating transmission zero), which results a complete stop of propagation through any chain of such cavity junctions.

The periodic structure can also be represented as an infinite transmission line characterized by a propagation wavenumber given by Equation (18).

$$γ = \frac{θ}{d + L} \qquad ( 18 )$$

5. Mathematical Modelling for Matching Quasi-Periodic LPF Structure with Input/Output Interfaces Over Passband

Over the lower propagation zone starting from DC to the beginning of the stop-band zone (when the propagation constant in Equation (18) is a real number), a periodic structure possesses a characteristic impedance and therefore can be matched with the I/O interface using common matching techniques.

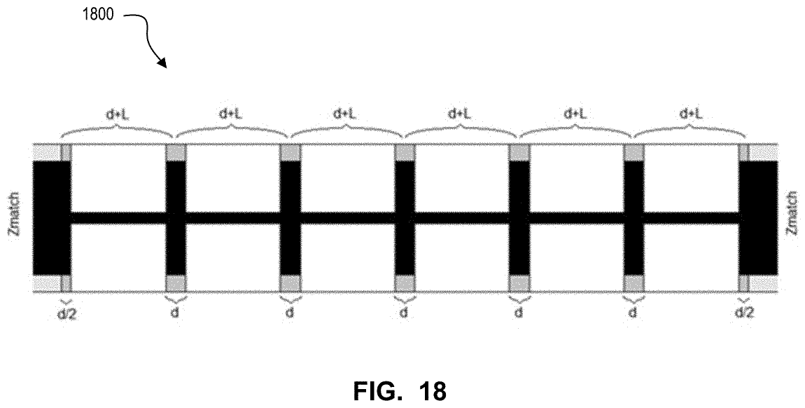

As a partial case, referring to FIG. 18 which shows an example periodic LPF structure 1800, theoretically, a fragment of the periodic structure can be directly (i.e., with no transforming) matched with an external interface of impedance Z_{match} at a single frequency point f_{c} if the equivalent characteristic impedance of the periodic Z_{c}(f_{c}) equals to Z_{match}.

Practically, however, the periodic structure can be slightly adjusted for a wider bandwidth by sensitive optimization of the pass-band over variations of some few dimensions. Since, in most applications, the frequencies of interest are within a narrow bandwidth, those slight adjustments are considered to be sufficient in order to achieve a good in-band performance. Such slight deviations from the periodical order are called “quasi-periodical” (i.e., a non-uniform transmission line with variable impedance and wave-number).

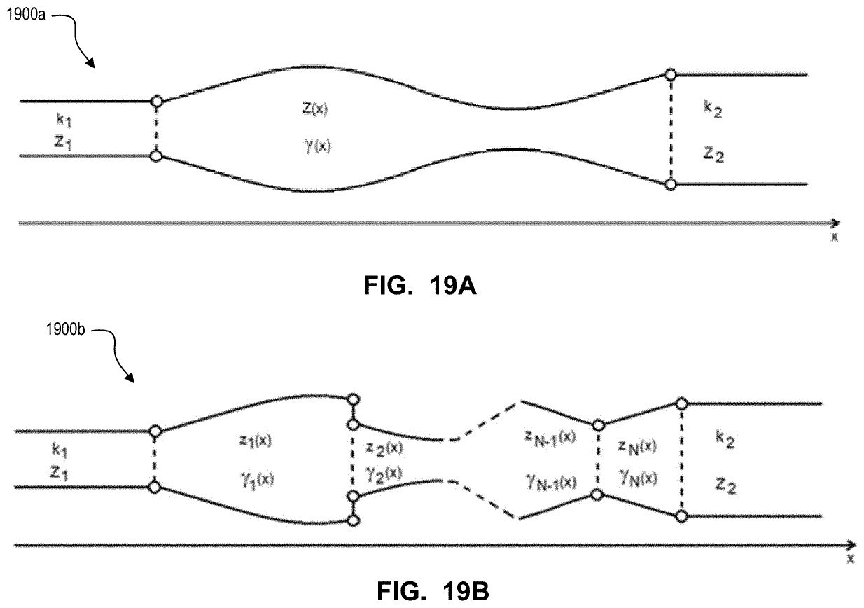

FIG. 19A shows a schematic representation 1900a that illustrates how a portion (i.e., cavity junction) of the quasi-periodic LPF structure—operating in the transmission passband—can be represented as an ideal transmission line having a characteristic impedance (z(x)) and a propagational wave number (y(x)), which varies as a function of the position (x) on a longitudinal axis of the filter portion. FIG. 19B shows a schematic representation 1900b illustrating multiple connections of quasi-periodic portions (i.e., cavity junctions), having corresponding impedance and propagational wave numbers.

As provided herein, the dimensions of the cavity junction elements can be gradually changed along the axis while keeping a certain impedance and propagation constant changing profile functions and keeping the structure matched with the constant impedance interface.

Since the propagation in a periodic structure can be defined as a transmission line with a wavenumber in accordance with Equation (18), and an impedance in accordance with Equation (17), the propagation can be approximated in accordance with Equations (19a) and (19b) (also known as the telegrapher's equation in R. E. Collins [5] and S. Ramo, J. R. Whinnery, T. V. Duzler [4]).

$$\begin{matrix}\frac{d}{dz} V ( z ) = - j \cdot γ ( z ) \cdot ζ ( z ) \cdot J ( z ) & ( 19 a ) \\ \frac{d}{dz} J ( z ) = - j \cdot γ ( z ) \cdot \frac{1}{ζ ( z )} \cdot V ( z ) & ( 19 b )\end{matrix}$$

wherein V(z) is the equivalent voltage, J(z) is the current, γ(z) is the wavenumber, and ζ(z) is the impedance, all of which are functions of longitudinal position. The last two parameters are defined in Equations (13) and (17) for a periodic structure composed by a cavity junction. In this case, however, the parameters become functions of the profile shape. This approximation of the scattering of a structure composed from cavity junctions is used to explain the basic operation of the disclosed novel structure.

Equations (19a) and (19b) can be reduced to a homogeneous second-order equation by substitution, in accordance with Equations (20a) and (20b):

$$\begin{matrix}J ( x ) = \frac{j}{γ ( x ) \cdot ζ ( x )} \cdot \frac{d}{dz} V ( z ) & ( 20 a ) \\ \frac{{d}^{2}}{{dx}^{2}} V ( z ) - ( \frac{{γ}^{′} ( x )}{γ ( x )} + \frac{{Z}_{c}^{′} ( x )}{ζ ( x )} ) \frac{d}{dz} V ( z ) + {γ}^{2} ( x ) \cdot V ( x ) = 0 & ( 20 b )\end{matrix}$$

If the differential Equations (20a) and (20b) are solved (e.g., numerically or asymptotically), two solutions are generated U₁(x), U₂(X) which are independent and satisfy the boundary conditions U₁(0)=0, U₂(L)=0. These solutions allow for deriving an expression for the 2×2 Y-matrix from the conditions of matching V(x),J(x) at the input (x=0) and output (x=L) ports in accordance with Equation (21).

$$Y = j ( \begin{matrix}\frac{1}{γ ( 0 ) ζ ( 0 )} \frac{{U}_{2}^{′} ( 0 )}{{U}_{2} ( 0 )} & \frac{1}{γ ( 0 ) ζ ( 0 )} \frac{{U}_{1}^{′} ( 0 )}{{U}_{1} ( L )} \\ \frac{- 1}{γ ( L ) ζ ( L )} \frac{{U}_{2}^{′} ( L )}{{U}_{2} ( 0 )} & \frac{- 1}{γ ( L ) ζ ( L )} \frac{{U}_{1}^{′} ( L )}{{U}_{1} ( L )}\end{matrix} ) \qquad ( 21 )$$

The Y-matrix in Equation (21) is symmetric (e.g., non-diagonal elements are equal), and can be represented by an equivalent Π-network (FIG. 16).

In general, Equation (21) cannot be solved using elementary functions. However, under certain assumptions (e.g., great values of γ(x)»1/L and small values of γ′(x)/γ(x)«1/L and ζ′(x)/ζ(x)«1/L) some simple asymptotic solutions can be withdrawn in simple terms in accordance with Equation (22).

$$Y = j ( \begin{matrix}\frac{- 1}{ζ ( 0 ) \cdot tan ( Θ ( L ) )} & \frac{1}{\sqrt{ζ ( 0 ) ζ ( L )} \cdot sin ( Θ ( L ) )} \\ \frac{1}{\sqrt{ζ ( 0 ) ζ ( L )} \cdot sin ( Θ ( L ) )} & \frac{- 1}{ζ ( L ) \cdot tan ( Θ ( L ) )}\end{matrix} ) , \\ Θ ( z ) = {\int }_{0}^{z} γ ( z ) \cdot dx \qquad ( 22 )$$

In Equation (22), the admittance matrix members depend on only the characteristic impedances at the ends ζ(0),ζ(L) and the integrate electrical phase Θ(L). Under those approximations, the quasi-periodic structure is matched if the characteristic impedances at the ends are equal to the impedances of the coaxial interface lines connected to them.

The same matching rule can also be applied to multiple connections of portions of different quasi-periodic structures composed from different cavity junctions, but having same effective characteristic impedance. Since the portions are treated as transmission line sections, they can be also matched using conventional stepped or tapered transforming.

Further, according to this analysis, the propagation stops at certain frequency point, when y₁₂ turns into zero and Θ(L₀) becomes imaginary infinity. In particular, the last condition happens at a certain frequency point and at a certain critical cross-section, which correspond to a cavity junction performing a transmission zero.

Accordingly, the quasi-periodic structure can be built in such a way that it is matched at a certain low frequency point (pass-band) and performs a set of transmission zeros corresponding different critical cross-sections and located in higher frequency bands.

6. Reducing High-Order Waveguide Mode Scattering

It has been appreciated that the propagation of the higher order modes can be significantly reduced or eliminated if the LPF structure is constructed in a certain order using cavity junctions having different spurious pass-bands.

The original mathematical model of the cavity junction (e.g., Equations (1) and (2)) is based on a rigorous variational solution of the problem of scattering on a junction of three waveguides and therefore can be directly used to accurately simulate a structure of those junctions connected to each other.

The analysis, however, is recognized as being complex and clear for the purpose of explaining the nature of the spurious pass-bands formed by the propagation of the higher order waveguide modes (i.e., not only TEM-mode considered in prior LPF design structures). In particular, it is theoretically understood, based on examining corrugated waveguide LPF structures (rather than coaxial structures) that spurious pass-bands are “shadows” of the scattering performance of the dominant mode. The spurious modes have a pass-band and stop-band as well, and those pass-bands and stop-bands result from the pass-band and stop-band of the dominant mode response as related by a frequency transform function (see e.g., S. Ramo, J. R. Whinnery, T. V. Duzler, [4]). Therefore, according to the theoretic understanding based on corrugated structures, the spurious pass-bands are always present and cannot be eliminated without changing a uniformity of the structure. However, it has been appreciated that this same effect has not been examined in respect of coaxial LPF structures.

In particular, it has been recognized herein that conventional coaxial low-pass filters, with uniform external and internal profile will show spurious propagation of higher order waveguide modes (TE₁₁, TE₂₁, etc.) with zero or insignificant attenuation on certain frequencies. Those frequencies are predefined from the design targets of conventional filters and cannot be avoided based on the conventional design.

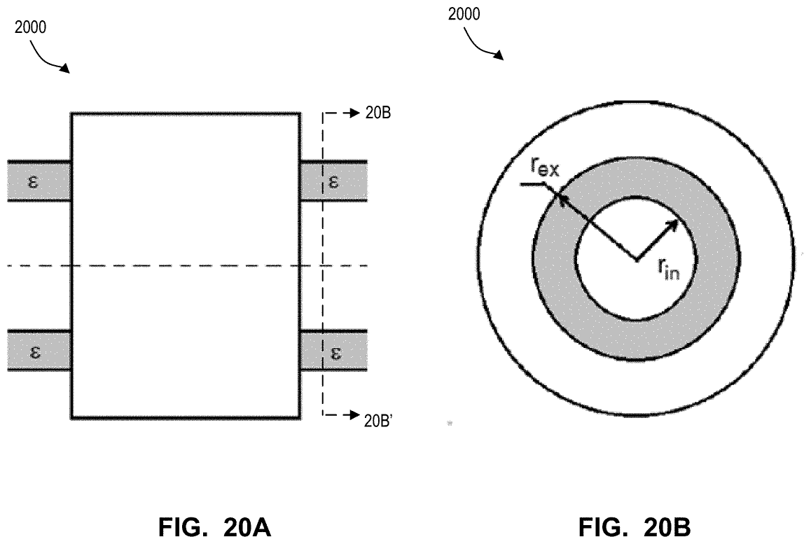

Referring now to FIGS. 20A and 20B, which show a symmetric cavity junction 2000. In the illustrated embodiment, the input/output nodes of the smaller coaxial line is filled with a dielectric with permittivity ε and permeability μ (relative to vacuum) and having the internal and external radii rᵢₙ and rₑₓ (e.g., 512a and 512b in FIG. 5B).

In some approximations, a frequency transform function can be defined from the equality of the propagational constant of a waveguide mode in the nodes. The cut-off frequency (f_{cn}) can be roughly approximated as the n-th waveguide mode in accordance with Equation (23).

$${f}_{cn} = \frac{1}{\sqrt{ɛ \cdot μ}} \cdot \frac{n \cdot c}{2 π \cdot {r}_{mid}} \qquad ( 23 )$$

where r_{mid} is a median radius defined as r_{mid}=(rₑₓ+rᵢₙ)/2.

Further, the number modes having a radially polarized electrical field (TEM, TE₁₁, TE₂₁, etc.) can be counted, because those modes are expected to have lower cut-off frequencies.

In Equation (23), the case where n=0 corresponds to the dominant TEM-mode, and if n>0, this corresponds to TEₙ₁-mode. Then, analogically based on reference a frequency transform function is derived in accordance with Equation (24) (see F. De Paolis, R. Goulouev, J. Zheng, M. Yu [6]):

$${f}_{t} ( n , f ) = \sqrt{{f}^{2} + \frac{1}{ɛ \cdot μ} \cdot {( \frac{n \cdot c}{2 π \cdot {r}_{mid}} )}^{2}} \qquad ( 24 )$$

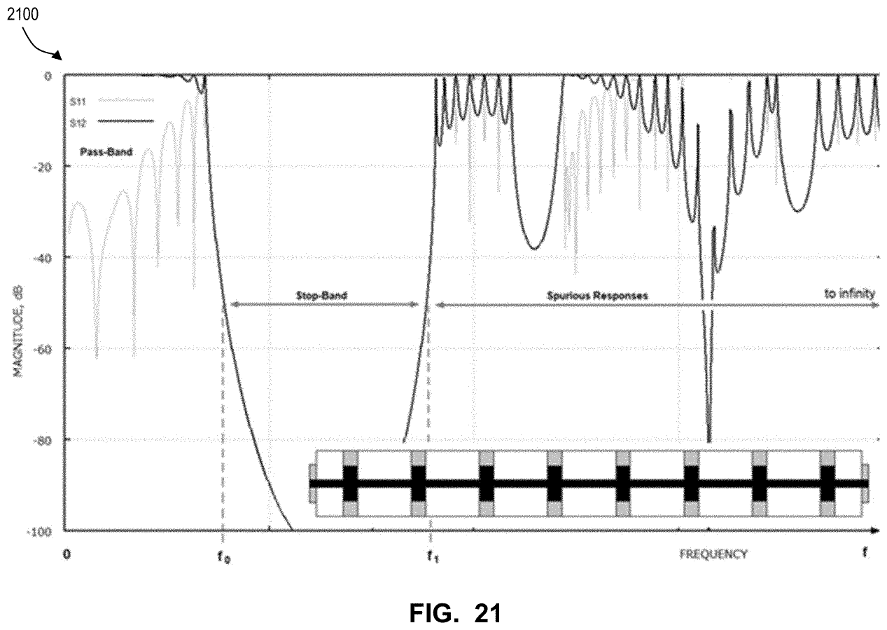

If an original transmission response (TEM-mode) of a structure composed from such cavities as a function of frequency (e.g., T(f)), is provided, the transmission response of a spurious TEₙ₁-mode is ideally Tₙ(f)=T(fₜ(n,f)). Further, it can be idealistically suggested that the coaxial low-pass filter has a pass-band starting from DC and extending to a roll-off frequency point f₀, which is considered as a starting frequency of the stop-band, with the stop-band ending frequency point being f₁ (FIG. 21). Further, the filter does not reject the frequencies greater than f₁ at all (e.g., all frequencies propagate with zero attenuation).

Based on the above, several inequalities can be derived defining some spurious zones. The TMₙ₁-mode propagates within those frequency bands and, in vice versa, it does not propagate outside those bands. The first inequality approximates the spurious bandwidth corresponding to the TEM-mode pass-band in accordance with Equation (25).

$${BW}_{0} ( n , f ) = \{ \begin{matrix}1 & if & \frac{1}{\sqrt{ɛ \cdot μ}} \cdot \frac{n \cdot c}{2 π \cdot {r}_{mid}} \leq f \leq \sqrt{{f}_{0}^{2} + \frac{1}{ɛ \cdot μ} \cdot {( \frac{n \cdot c}{2 π \cdot {r}_{mid}} )}^{2}} \\ 0 & if & else\end{matrix} \qquad ( 25 )$$

The second spurious bandwidth corresponds to the transform of the frequencies higher than the TEM-mode stop-band, which can be expressed according to Equation (26).

$${BW}_{1} ( n , f ) = \{ \begin{matrix}1 & if & f \geq \sqrt{{f}_{1}^{2} + \frac{1}{ɛ \cdot μ} \cdot {( \frac{n \cdot c}{2 π \cdot {r}_{mid}} )}^{2}} \\ 0 & if & else\end{matrix} \qquad ( 26 )$$

Assuming that the filter is symmetrically (keeping rotational symmetry) connected to an external semi-infinitive coaxial port (the interface) at each end, which has an equivalent median radius rᵢₙₜ, then Equation (27) is provided for the interface bandwidth:

$${BW}_{int} ( n , f ) = \{ \begin{matrix}1 & if & f \geq \frac{1}{\sqrt{{ɛ}_{int} \cdot {μ}_{int}}} \cdot \frac{n \cdot c}{2 π \cdot {r}_{int}} \\ 0 & if & else\end{matrix} \qquad ( 27 )$$

Under an assumption that the entire filter structure is ideally rotationally symmetric, it has been appreciated that there cannot be any coupling or conversion between the waveguide modes of different n-indeces. Therefore, the resulting overall bandwidth of n-spurious propagation can be defined as mathematical intersection of all those frequency sets defined above.

Accordingly, for a rotationally symmetric composite low-pass filter consisting from a few sub-filters (each of them is indexed a number i∈(1,2, . . . N)), the resulting spurious bandwidth can be expressed as an intersection of all sub-bands defined above corresponding to all sub-filters and can be expressed according to Equation (28).

BW(n,f)=BWᵢₙₜ(n,f)·Πᵢ₌₁^{N}(BW₀⁽ⁱ⁾(n,f)·BW₁⁽ⁱ⁾(n,f)) (28)

A similar approach can be applied to a smoothly formed profiles using a discrete differentiation of the forming function into sub-shapes of constant interior.

The above formulation is based on approximations and provided to demonstrate the basic principles of the elimination of the TMₙ₁ spurious pass-bands and response spikes. Since the low cut-off and high cut-off filters concept assumes different radii r_{mid} in low impedance sections (commonly r_{mid}^{high}/r_{mid}^{low}≈0.4÷0.5) is usually.

Therefore, using the common method of building filter assemblies from a low cut-off filter with a stop-band f₀⁽¹⁾÷f₁⁽¹⁾, and a high cut-off filter with a stop-band f₀⁽²⁾÷∞, it is expected that the TMₙ₁—mode spurious is location within the band expressed by Equation (29).

$$max ( \frac{1}{\sqrt{{ɛ}_{int} \cdot {μ}_{int}}} \cdot \frac{n \cdot c}{2 π \cdot {r}_{int}} , \sqrt{{( {f}_{1}^{( 1 )} )}^{2} + \frac{1}{ɛ \cdot μ} \cdot {( \frac{n \cdot c}{2 π \cdot {r}_{mid}^{( 1 )}} )}^{2}} ) \leq f \leq \sqrt{{( {f}_{0}^{( 2 )} )}^{2} + \frac{1}{ɛ \cdot μ} \cdot {( \frac{n \cdot c}{2 π \cdot {r}_{mid}^{( 2 )}} )}^{2}} \qquad ( 29 )$$

Equation (28) can be used for designing a spurious-less composite filter consisting from low cut-off and high cut-off portions. The generalized Equation (27) can be used to eliminate the spurious TMₙ₁ responses in more complex structures.

### REFERENCES

[1] F. De Paolis, R. Goulouev, J. Zheng, M. Yu, “CAD Procedure for High-Performance Composite Corrugated Filters”, IEEE Trans. Microw. Theory Tech., vol. MTT-61, No. 9, September 2013
[2] N. Marcuvitz, “Waveguide Handbook,” Polytechnic Ins. Of New York, 1985.
[3] R. E. Collin, “Field Theory of Guided Waves,” IEEE Press, 1991
[4] S. Ramo, J. R. Whinnery, T. V. Duzler, “Fields and Waves in Communication Electronics,” John Willey & Sons, New York, 1965.
[5] R. E. Collin, “Foundations for microwave engineering,” Second Edition, McGraw-Hill, New York, 1992.

1. A coaxial low-pass filter operable to generate a stopband by a controlled generation of transmission zeroes within a stopband frequency range, the coaxial filter comprising:
a plurality of cavity junctions arranged in cascaded sequence, each of the plurality of cavity junctions operable to generate at least one corresponding cavity-specific transmission zero through a dual-mode coupling of a transverse electromagnetic (TEM) resonant mode and a transverse magnetic (TM) resonant mode, the at least one cavity-specific transmission zero being generated at at least one corresponding cavity-specific frequency located within the stopband frequency range,
wherein for each of the plurality of cavity junctions, the location of the at least one corresponding cavity-specific frequency is adjusted by adjusting at least one property of the corresponding cavity junction,
wherein a scattering of the locations of each of the cavity-specific transmission zeroes, generated by each of the plurality of cavity junctions, generates the stopband at the desired frequency range.

2. The coaxial filter of claim 1, wherein for at least a subset of the plurality of cavity junctions, the transverse electromagnetic (TEM) resonant mode is a TEM₁ resonant mode, and the transverse magnetic (TM) resonant mode is a TM₀₁₀ resonant mode.

3. The coaxial filter of claim 1, wherein for at least a subset of the plurality of cavity junctions, the transverse electromagnetic (TEM) resonant mode is a TEM₁ resonant mode, and the transverse magnetic (TM) resonant mode is a TM₀₂₀ resonant mode.

4. The coaxial filter of claim 1, wherein the plurality of cavity junctions comprise a first plurality of cavity junctions and a second plurality of cavity junctions, wherein for the first plurality cavity junctions the transverse electromagnetic (TEM) resonant mode is a TEM₁ resonant mode, and the transverse magnetic (TM) resonant mode is a TM₀₁₀ resonant mode, and for the second plurality cavity junctions the transverse electromagnetic (TEM) resonant mode is a TEM₁ resonant mode, and the transverse magnetic (TM) resonant mode is a TM₀₂₀ resonant mode.

5. The coaxial filter of claim 2, wherein the at least subset of the plurality of cavity junctions generate transmission zeroes located at a near stopband region.

6. The coaxial filter of claim 5, wherein the at least subset of the plurality of cavity junctions generate a low cut-off filter response.

7. The coaxial filter of claim 3, wherein the at least subset of the plurality of cavity junctions generate transmission zeroes located at a far stopband region.

8. The coaxial filter of claim 7, wherein the at least subset of the plurality of cavity junctions generate a high cut-off filter response for the coaxial filter.

9. The coaxial filter of claim 1, wherein the at least one cavity-specific transmission zero comprises at least one of: two transmission zeroes generated at two corresponding cavity-specific frequencies, two transmission zeroes regenerated at a single cavity-specific frequency and a single transmission zero at a single cavity-specific frequency.

10. The coaxial filter of claim 1, wherein the plurality of cavity junctions are cascaded in at least one of a periodic or quasi-periodic sequence.

11. The coaxial filter of claim 1, wherein the at least one property comprises at least one of a length dimension of the cavity junction and a radius dimension of the cavity junction.

12. The coaxial filter of claim 1, wherein the coaxial low-pass filter has a constant filter exterior resulting from the plurality of cavity junctions each having a constant cavity-specific radius.

13. The coaxial filter of claim 1, wherein the coaxial low-pass filter has a tapered filter exterior resulting from the plurality of cavity junctions each having a variable cavity-specific radius.

14. The coaxial filter of claim 4, wherein the coaxial low-pass filter has a stepped composite profile.

15. The coaxial filter of claim 4, wherein the coaxial low-pass filter has a stepped and tampered composite profile.

16. The coaxial filter of claim 1, wherein the coaxial filter is used in at least one of real frequency (RF) or microwave communication.

17. The coaxial filter of claim 16, wherein the coaxial filter is used in satellite communication.

18. The coaxial filter of claim 1, wherein the coaxial filter is used for low-frequency communication applications.

19. The coaxial filter of claim 1, wherein the coaxial filter includes an input node and an output node, each of the input and output nodes are coupled to a coaxial transmission line carrying a transmission signal.

20. The coaxial filter of claim 1, wherein the stopband is an extended spurious-free stopband range.
